(19) United States
(12) Patent Application Publication
(10) Pub. No.: US 2009/0113896 A1
(43) Pub. Date: May 7, 2009

(54) Control apparatus and method for gas-turbine engine

(75) Inventor: Daiki Fukuda, Fuji-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Toyota Jidosha Kabushiki Kaisha

(21) Appl. No.: 12/000,395

(22) Filed: Dec. 12, 2007

(30) Foreign Application Priority Data
Dec. 12, 2006 (JP) 2006-334896

(51) Int. Cl. F02C 6/04

(52) U.S. Cl. 60/784; 701/100

(57) ABSTRACT

There is provided a control apparatus for a gas-turbine engine which is configured in such a manner that a portion of compressed air from a compressor is supplied to a combustion chamber and the other portion of the compressed air is sent to the outside of the engine to be used as source of energy, and a turbine is rotated by combustion gas produced in the combustion chamber. The control apparatus executes the optimum combustion control in an extraction engine. The control apparatus calculates the physical quantity related to the air in the gas-turbine engine using the turbine flow-rate coefficient in the range in which the turbine chokes.

### INCORPORATION BY REFERENCE

The disclosure of Japanese Patent Application No. 2006-334896 filed on Dec. 12, 2006 including the specification, drawings and abstract is incorporated herein by reference in its totalty.

### BACKGROUND OF THE INVENTION

1. Field of the Invention

The invention relates to a control apparatus and method for an extraction gas-turbine engine which is configured in such a manner that the compressed air from a compressor is sent to the outside of the engine to be used as source of energy.

2. Description of the Related Art

In a gas-turbine engine, air is taken into a compressor and compressed therein. Then, the compressed air is sent to a combustion chamber, mixed with the fuel, and burned therein. A turbine is rotated by the combustion gas. One type of gas-turbine engines is a shaft-output engine which outputs power through a rotating shaft connected to a turbine. Another type of gas-turbine engines is an extraction engine. The engine of this type outputs a portion of the compressed air from a compressor as power. For example, Japanese Patent Application Publication No. 2006-213168 (JP-A-2006-213168) describes an extraction engine. With this extraction engine, thrust is produced by a thrust producer of a vertical takeoff and landing aircraft using the compressed air as source of energy. Japanese Patent Application Publication No. 11-352284 (JP-A-11-352284) describes a gas-turbine engine.

In the case of a shaft-output engine, the flow-rate of the air compressed by a compressor matches the flow-rate of the air flowing into a combustion chamber. Therefore, the flow-rate of the air flowing into the combustion chamber can be estimated based on the compressor characteristics, and a control over the combustion that takes place in the combustion chamber can be executed based on the estimated flow-rate of the air. In contrast, in the case of an extraction engine, a portion of the air compressed by a compressor is sent to the outside of the engine. Therefore, the flow-rate of the air compressed by the compressor does not match the flow-rate of the air flowing into a combustion chamber. Also, the flow-rate of the extracted air changes depending on the operating state of a loading apparatus provided on the outside of the engine. Accordingly, the flow-rate of the air flowing into the combustion chamber changes in accordance with a change in the flow-rate of the extracted air. Therefore, in the extraction engine, the flow-rate of the air flowing into the combustion chamber cannot be estimated according to an estimation method employed for a shaft-output engine. Accordingly, the flow-rate of the air flowing into the combustion chamber cannot be accurately detected. In a gas-turbine engine, there is required an air flow-rate which is approximately ten times as high as the air flow-rate required in a piston engine that produces approximately the same amount of power as that of the gas-turbine engine. Therefore, it is difficult to directly measure the air flow-rate, for example, the flow-rate of the extracted air, because the power output from the engine is reduced under the influence of, for example, an increase in a pressure loss in a passage. As a result, in a conventional extraction engine, the optimum control over the combustion that takes place in a combustion chamber cannot be executed, because the flow-rate of the air flowing into the combustion chamber cannot be accurately detected.

### SUMMARY OF THE INVENTION

The invention provides a control apparatus and method for a gas-turbine engine, which executes the optimum combustion control in an extraction engine.

A first aspect of the invention relates to a control apparatus for a gas-turbine engine that is configured in such a manner that a portion of compressed air from a compressor is supplied to a combustion chamber and the other portion of the compressed air is sent to the outside of the engine to be used as source of energy, and a turbine is rotated by combustion gas produced in the combustion chamber. The control apparatus includes a characteristic value detection unit that detects a characteristic value exhibited by the turbine; and a physical quantity calculation unit that calculates a physical quantity related to air in the gas-turbine engine, using the characteristic value detected by the characteristic value detection unit.

The gas-turbine engine is configured in such a manner that a portion of the compressed air from the compressor is supplied to the combustion chamber and the other portion of the compressed air is sent to the outside of the engine to be used as source of energy. In the gas-turbine engine, the compressed air and the fuel are mixed together and burned in the combustion chamber, and the turbine is rotated by combustion gas produced in the combustion chamber. At this time, the control apparatus executes the combustion control by adjusting the flow-rate of the fuel supplied to the combustion chamber. Especially, the control apparatus calculates the physical quantity related to the air in the gas-turbine engine using the characteristic value exhibited by the turbine, and executes the combustion control based on the physical quantity. Because the control apparatus is able to obtain the physical quantity related to the air in the gas-turbine engine using the turbine characteristic, the optimum combustion control is executed.

In the control apparatus according to the first aspect of the invention, the physical quantity related to the air in the gas-turbine engine may be a flow-rate of the air supplied to the combustion chamber. The control apparatus calculates the flow-rate of the air supplied to the combustion chamber using the characteristic value exhibited by the turbine, obtains the flow-rate of the fuel supplied to the combustion chamber based on the flow-rate of the air supplied to the combustion chamber, and executes the combustion control. As described above, the control apparatus accurately obtains the flow-rate of the air supplied to the combustion chamber without using means for directly measuring the air flow-rate, independently of a change in the extracted air flow-rate. Accordingly, it is possible to execute the optimum combustion control.

In the control apparatus according to the first aspect of the invention, the characteristic value exhibited by the turbine may be a flow-rate coefficient of the turbine; and the control apparatus may further include a first combustion chamber-supplied air flow-rate calculation unit that calculates the flow-rate of the air supplied to the combustion chamber using the flow-rate coefficient of the turbine, when the operating state of the turbine is in the range in which the turbine chokes. The control apparatus calculates the flow-rate of the air supplied to the combustion chamber using the turbine flow-rate coefficient, when the operating state of the turbine is in the range in which the turbine chokes (the actual use range of the engine), and executes the combustion control based on the flow-rate of the air supplied to the combustion chamber. In the range in which the turbine chokes, the turbine flow-rate coefficient is maintained at a constant value (a specific value corresponding to the type of the engine). Therefore, it is possible to obtain the flow-rate of the air supplied to the combustion chamber using the specific value.

The control apparatus according to the first aspect of the invention may further include: a turbine-supplied gas flow-rate detection unit that detects a flow-rate of the gas supplied to the turbine when the operating state of the turbine is in the range in which the turbine chokes; a turbine-inlet gas pressure detection unit that detects a pressure of the gas at an inlet of the turbine; a fuel-air ratio determination unit that determines a fuel-air ratio in the combustion chamber; and a second combustion chamber-supplied air flow-rate calculation unit that calculates the flow-rate of the air supplied to the combustion chamber using the flow-rate of the gas supplied to the turbine, the pressure of the gas at the inlet of the turbine, and the fuel-air ratio in the combustion chamber, according to a turbine flow-rate coefficient equation. The turbine flow-rate coefficient equation is an equation according to which the flow-rate coefficient is determined based on the flow-rate of the gas supplied to the turbine, the pressure of the gas at the inlet of the turbine, and the temperature of the gas at the inlet of the turbine. In the range in which the turbine chokes, the turbine flow-rate coefficient is maintained at a constant value. The fuel-air ratio in the combustion chamber is a ratio between the flow-rate of the air supplied to the combustion chamber and the flow-rate of the fuel supplied to the combustion chamber. The temperature of the gas at the inlet of the turbine is the sum of the temperature of the gas at the inlet of the combustion chamber and an increase in the temperature in the combustion chamber. Based on the temperature characteristic in the combustion chamber, an increase in the temperature in the combustion chamber is indicated by a function of the temperature of the gas at the inlet of the combustion chamber and the fuel-air ratio. The flow-rate of the gas supplied to the turbine is regarded as being substantially equal to the flow-rate of the air supplied to the combustion chamber. Therefore, using the relationships described above makes it possible to easily obtain the flow-rate of the air supplied to the combustion chamber based on the flow-rate of the gas supplied to the turbine, the pressure of the gas at the inlet of the turbine and the fuel-air ratio in the combustion chamber, using the turbine flow-rate coefficient.

In the control apparatus according to the first aspect of the invention, the physical quantity related to the air in the gas-turbine engine may be a temperature of the gas at the inlet of the turbine. The control apparatus calculates the temperature of the gas at the inlet of the turbine using the characteristic value exhibited by the turbine, and executes the combustion control based on the temperature of the gas at the inlet of the turbine. As described above, the control apparatus accurately obtains the temperature of the gas at the inlet of the turbine, of which the temperature becomes high, without using means for directly measuring the temperature of the gas at the inlet of the turbine. Accordingly, it is possible to execute the optimum combustion control. Because the temperature of the turbine becomes the highest in gas-turbine engine, it is necessary to control the temperature of the gas at the inlet of the turbine in such a manner that the temperature of the gas at the inlet of the turbine does not exceed a permissible maximum temperature, and execute the combustion control.

In the control apparatus according to the first aspect of the invention, the characteristic value exhibited by the turbine may be a flow-rate coefficient of the turbine; and the control apparatus may further include a first turbine-inlet gas temperature calculation unit that calculates the temperature of the gas at the inlet of the turbine using the flow-rate coefficient of the turbine, when the operating state of the turbine is in the range in which the turbine chokes. The control apparatus calculates the temperature of the gas at the inlet of the turbine using the turbine flow-rate coefficient (constant value) in the range in which the turbine chokes, and executes the combustion control based on the temperature of the gas at the inlet of the turbine.

The control apparatus according to the first aspect of the invention may further include: a combustion chamber-supplied air flow-rate detection unit that detects a flow-rate of the air supplied to the combustion chamber, when the operating state of the turbine is in the range in which the turbine chokes; a turbine-inlet gas pressure detection unit that detects a pressure of the gas at the inlet of the turbine; and a second turbine-inlet gas temperature calculation unit that calculates the temperature of the gas at the inlet of the turbine using the flow-rate of the air supplied to the combustion chamber and the pressure of the gas at the inlet of the turbine, according to a turbine flow-rate coefficient equation. Using the above-described turbine flow-rate coefficient and the relationship between the flow-rate of the gas supplied to the turbine and the flow-rate of the air supplied to the combustion chamber makes it possible to easily obtain the temperature of the gas at the inlet of the turbine based on the flow-rate of the air supplied to the combustion chamber and the pressure at the inlet of the turbine, according to the turbine flow-rate coefficient equation.

In the control apparatus according to the first aspect of the invention, the physical quantity related to the air in the gas-turbine engine may be an extracted air flow-rate of the air taken out from the compressor as the source of energy, the characteristic value exhibited by the turbine may be a flow-rate coefficient of the turbine, and the control apparatus may further include: a supercharged air flow-rate detection unit that detects a flow-rate of air supercharged by the compressor; and an extracted air flow-rate calculation unit that calculates the extracted air flow-rate based on a difference between the flow-rate of the supercharged air and a flow-rate of the air supplied to the combustion chamber, which is determined based on the flow-rate coefficient of the turbine. The control apparatus calculates the flow-rate of the air supplied to the combustion chamber using the turbine flow-rate coefficient, and calculates an extracted air flow-rate of the air from the compressor by subtracting the flow-rate of the air supplied to the combustion chamber from the flow-rate of the air supercharged by the compressor. As described above, the control apparatus accurately obtain the extracted air flow-rate without using means for directly measuring the extracted air flow-rate. Accordingly, it is possible to execute the optimum combustion control. Using the obtained extracted air flow-rate makes it possible to determine the power produced by the loading apparatus that uses the compressed air from the compressor as source of power, and to accurately control the load.

A second aspect of the invention relates to a control apparatus for a gas-turbine engine that is configured in such a manner that a portion of compressed air from a compressor is supplied to a combustion chamber and the other portion of the compressed air is sent to an outside of the engine to be used as source of energy, and a turbine is rotated by combustion gas produced in the combustion chamber. The control apparatus includes: a target combustion chamber-supplied air flow-rate detection unit that detects a target flow-rate of the air supplied to the combustion chamber when the operating state of the compressor is near the border of a surging range of the compressor; a target temperature determination unit that determines a target temperature of gas at an inlet of the turbine; and a combustion chamber-supplied fuel flow-rate calculation unit that calculates a flow-rate of fuel supplied to the combustion chamber when an engine speed is increasing, using the target flow-rate of the air supplied to the combustion chamber and the target temperature of the gas at the inlet of the turbine.

The gas-turbine engine is configured in such a manner that a portion of compressed air from the compressor is supplied to the combustion chamber and the other portion of the compressed air is sent to the outside of the engine to be used as source of energy. In the gas-turbine engine, the compressed air and the fuel are mixed together and burned in the combustion chamber, and the turbine is rotated by combustion gas produced in the combustion chamber. In such an extraction engine, as the extracted air flow-rate decreases, power surges are more likely to occur in the compressor. In the gas-turbine engine, the excess power from the turbine increases (consequently, the speed-up performance of the engine is enhanced) by increasing the temperature of the gas at the inlet of the turbine. It is necessary to maintain the temperature of the gas at the inlet of the turbine at a value equal to or lower than the permissible maximum temperature. Therefore, when the engine speed is increased, it is necessary to maintain the temperature of the gas at the inlet of the turbine as high as possible to the extent that power surges do not occur in the compressor. Therefore, when the engine speed is increased, the target flow-rate of the air supplied to the combustion chamber when the operating state is near the border of the surging range of the compressor is obtained, and the target temperature of the gas at the inlet of the turbine is obtained. The control apparatus obtains the flow-rate of the fuel supplied to the combustion chamber when the engine speed is increasing, based on the target flow-rate of the air supplied to the combustion chamber. At the obtained flow-rate of the fuel supplied to the combustion chamber, the target temperature of the gas at the inlet of the turbine is maintained at a value near the permissible maximum temperature. As described above, the control apparatus is able to execute the optimum combustion control at the engine speed-up time while avoiding occurrence of power surges, even if the extracted air flow-rate changes.

The control apparatus according to the second aspect of the invention may further include: an extracted air flow-rate adjustment unit that releases air from the compressor; and a released air flow-rate adjustment unit that adjusts a flow-rate of the air released from the compressor by the extracted air flow-rate adjustment unit so that the target temperature of the gas at the inlet of the turbine matches a permissible maximum temperature, when the engine speed is increasing. The control apparatus adjusts the flow-rate of the air released from the compressor by the extracted air flow-rate adjustment unit to adjust the flow-rate of the air taken out from the compressor so that the target temperature of the gas at the inlet of the turbine matches the permissible maximum temperature at the engine speed-up time. Adjusting the extracted air flow-rate in the above-described manner makes it possible to maintain the temperature of the gas at the inlet of the turbine at a value near the permissible maximum temperature while avoiding power surges in the compressor. As a result, it is possible to increase the excess power from the turbine. Consequently, the speed-up performance of the engine is enhanced.

According to the aspects of the invention described above, it is possible to accurately obtain the flow-rate of the air supplied to the combustion chamber, etc. without using means for performing direct measurement, and to the execute the optimum combustion control.

### BRIEF DESCRIPTION OF THE DRAWINGS

The foregoing and further objects, features and advantages of the invention will become apparent from the following description of an example embodiment with reference to the accompanying drawings, wherein the same or corresponding portions will be denoted by the same reference numerals and wherein:

FIG. 1 is a diagram schematically showing the structure of a gas-turbine engine system according to an embodiment of the invention;

FIG. 2 is a view showing an example of a loading apparatus in FIG. 1;

FIG. 3 is a graph showing the flow characteristic of a turbine of a gas-turbine engine, the flow characteristic being the relationship between the turbine expansion ratio and the turbine flow-rate coefficient;

FIG. 4 is a graph showing the temperature characteristic in a combustion chamber of the gas-turbine engine, the temperature characteristic being the relationship between the fuel-air ratio in the combustion chamber and a temperature increase in the combustion chamber when the combustion chamber inlet air temperature is used as a parameter;

FIG. 5 is a flowchart showing the combustion chamber inflow air flow-rate detection routine, which is executed by an engine control ECU in FIG. 1;

FIG. 6 is a flowchart showing the turbine inlet gas temperature detection routine, which is executed by the engine control ECU in FIG. 1;

FIG. 7 is a compressor map (map showing the relationship between the corrected total air flow-rate and the pressure ratio);

FIG. 8 is a flowchart showing the extracted air flow-rate detection routine, which is executed by the engine control ECU in FIG. 1;

FIG. 9 is a graph showing a compressor map with the engine operating line in the case of a shaft-output gas-turbine engine;

FIG. 10 is a graph showing a compressor map with the engine operating line in the case of an extraction gas-turbine engine;

FIG. 11 is a graph showing a compressor map with the speed-up time engine operating line;

FIG. 12 is a flowchart showing the first speed-up time maximum fuel flow-rate control routine, which is executed by the engine control ECU in FIG. 1;

FIG. 13 is a graph showing a compressor map with the speed-up time engine operating line;

FIG. 14 is a flowchart showing the second speed-up time maximum fuel flow-rate control routine, which is executed by the engine control ECU in FIG. 1;

FIG. 15 is a graph showing the engine characteristic exhibited near the border of the surging range of the extraction gas-turbine-engine, the engine characteristic being the relationship between the engine speed and the extracted air flow-rate when the target turbine inlet gas temperature is used as a parameter;

FIG. 16 is a graph showing the engine characteristic exhibited near the border of the surging range of the extraction gar-turbine-engine, the engine characteristic being the relationship between the engine speed and the excess power from the turbine when the target turbine inlet gas temperature is used as a parameter;

FIG. 17A is a time chart showing a time-change in the engine speed when the engine speed is increasing;

FIG. 17B is a time chart showing a time-change in the turbine inlet gas temperature when the engine speed is increasing;

FIG. 17C is a time chart showing a time-change in the opening amount of a blowoff control valve when the engine speed is increasing; and

FIG. 18 is a flowchart showing the blowoff control valve control routine, which is executed by the engine control ECU in FIG. 1;

### DETAILED DESCRIPTION OF THE EXAMPLE EMBODIMENT

Hereafter, a control apparatus for a gas-turbine engine according to an embodiment of the invention will be described with reference to the accompanying drawings.

A control apparatus for a gas-turbine engine according to an embodiment of the invention is applied to an engine control ECU that executes a combustion control over a uniaxial extraction gas-turbine engine. According to the embodiment of the invention, the compressed air taken out from the gas-turbine engine is used as the energy for a loading apparatus, and a load control ECU that executes a drive control over the loading apparatus is also provided. In the embodiment of the invention, a system that is formed of the gas-turbine engine, the loading apparatus, the engine control ECU, the load control ECU, etc. is referred to as a gas-turbine engine system.

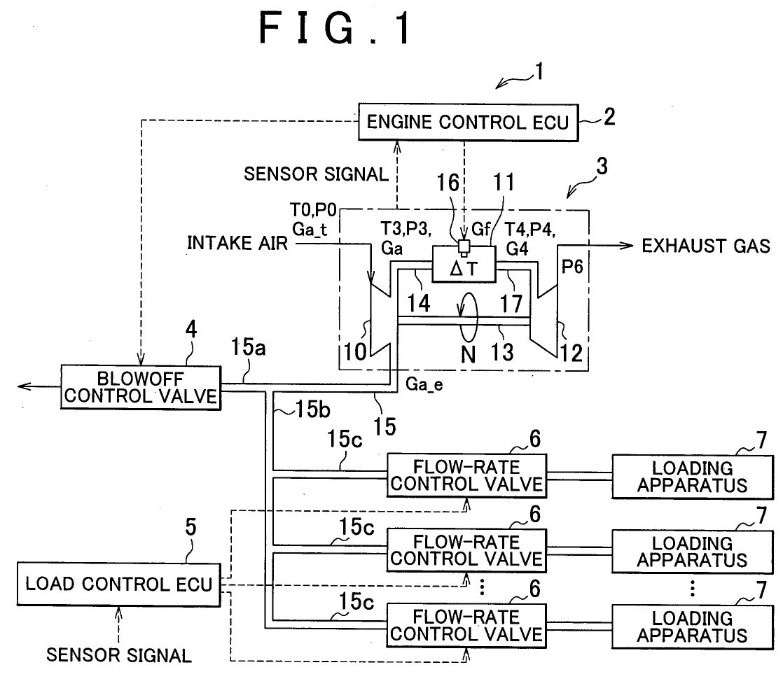

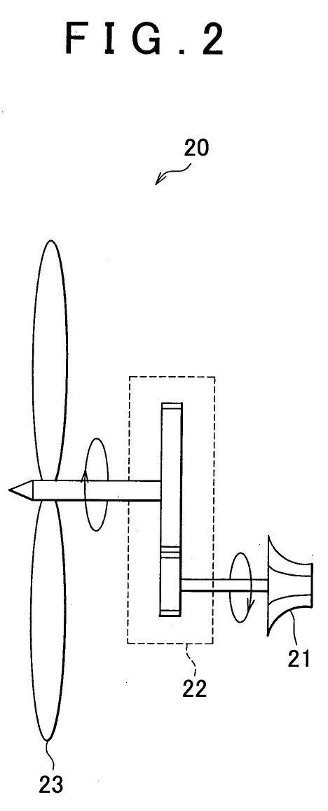

A gas-turbine engine system 1 will be described with reference to FIGS. 1 and 2. FIG. 1 is a view showing the configuration of the gas-turbine engine system 1 according to the embodiment of the invention. FIG. 2 shows an example of the loading apparatus in FIG. 1.

In the gas-turbine engine system 1, an engine control ECU 2 executes a combustion control over a gas-turbine engine 3 and a drive control over a blowoff control valve 4 (extracted air flow-rate adjusting means). With the gas-turbine engine system 1, the compressed air that is produced in the gas-turbine engine 3 is taken out to the outside of the engine to be used on the outside of the engine, and is also used for combustion that takes place in the engine. In the gas-turbine engine system 1, a load control ECU 5 executes a drive control over multiple flow-rate control valves 6. In the gas-turbine engine system 1, multiple loading apparatuses 7 are driven by the compressed air adjusted by the respective flow-rate control valves 6. The gas-turbine engine-system 1 is applied to, for example, a vertical takeoff and landing aircraft.

The gas-turbine engine 3 includes a compressor 10, a combustion chamber 11, and a turbine 12. The compressor 10 and the turbine 12 are connected to each other by a rotating shaft 13. The compressor 10 rotates in response to the rotation of the rotating shaft 13 to take in the air from the atmosphere, and compresses the air. The high-temperature and high-pressure compressed air is supplied to the combustion chamber 11 through an inner pipe 14, and discharged to the outside of the engine through an extraction pipe 15. The extraction pipe 15 branches off into a discharge pipe 15a that leads to the blowoff control valve 4, and a load pipe 15b that leads to the loading apparatuses 7. In the combustion chamber 11, the compressed air supplied from the compressor 10 and the fuel supplied from a fuel injection device 16 are mixed together and the air-fuel mixture is burned. The high-temperature and high-pressure combustion gas is supplied to the turbine 12 through an inner pipe 17. The turbine 12 is rotated by the supplied combustion gas to rotate the rotating shaft 13. The combustion gas is discharged from the turbine 12. The fuel injection device 16 is provided to the combustion chamber 11, receives a fuel control signal from the engine control ECU 2, and injects fuel into the combustion chamber 11 according to the fuel control signal.

Various sensors (not shown) are provided to and near the gas-turbine engine 3 to detect various state quantities that are required for the control executed by the engine control ECU 2. There are provided, for example, a temperature sensor that detects the atmospheric temperature T0 (the temperature of the air taken in the compressor 10), a pressure sensor that detects the atmospheric pressure P0 (the pressure of the air taken in the compressor 10), a pressure sensor that detects the pressure P3 at the outlet of the compressor 10 (the pressure at the inlet of the combustion chamber 11), a temperature sensor that detects the temperature T3 of the air at the inlet of the combustion chamber 11 (the temperature of the air at the outlet of the compressor 10), and an engine speed sensor that detects the rotational speed of the rotating shaft 13 (the engine speed N).

The blowoff control valve 4 is a control valve that adjusts the rate of the amount of air discharged into the atmosphere to the amount of compressed air from the compressor 10 to adjust the rate of the amount of compressed air taken out to the outside of the engine to the amount of compressed air from the compressor 10 (extracted air flow-rate). This adjustment made by the blowoff control valve 4 optimizes the extracted air flow-rate on the gas-turbine engine 3 side based on the extracted air flow-rate required on the loading apparatus 7 side. The blowoff control valve 4 is provided at the downstream end of the exhaust pipe 15a. The blowoff control valve 4 is provided with an actuator formed of, for example, an electric motor. The opening amount of the blowoff control valve 4 is changed by the actuator. The blowoff control valve 4 receives an extracted air flow-rate control signal from the engine control ECU 2. The actuator is driven according to the extracted air flow-rate control signal to open or close the blowoff control valve 4.

The flow-rate control valves 6 are provided to the respective loading apparatuses 7, and adjust the flow-rate of the compressed air supplied to the loading apparatuses 7. The flow-rate control valves 6 are provided at middle portions of respective branch pipes 15c. The branch pipes 15c branch off from the load pipe 15b, and are provided to the respective loading apparatuses 7. The flow-rate control valves 6 are provided with actuators that are formed of, for example, electric motors. The opening amount of the flow-rate control valve 6 is changed by the actuator. The flow-rate control valve 6 receives a load flow-rate control signal from the load control ECU 5. The actuator is driven according to the load flow-rate control signal to open or close the flow-rate control valve 6.

Each loading apparatus 7 is provided at the downstream end of the corresponding branch pipe 15c, and is able to use the high-temperature and high-pressure compressed air for energy. For example, in the case of the vertical takeoff and landing aircraft, the loading apparatus 7 is applied to a thrust producing fan 20 that produces thrust which is applied in the direction perpendicular to the aircraft. The vertical takeoff and landing aircraft is provided with multiple loading apparatuses 7. The loading apparatuses 7 are provided at the front portion, the rear portion, the right portion, and the left portion of the aircraft. The thrust producing fan 20 includes a turbine 21, a reducer 22, and a propeller 23, as shown in FIG. 2. The supplied compressed air is introduced into the turbine 21 and expands therein. The turbine 21 is rotated by the energy that is generated when the compressed air expands. The rotational drive power produced by the turbine is reduced by the reducer 22 at a predetermined speed reduction ratio, and the reduced rotational drive power is transmitted to the propeller 23. The propeller 23 is rotated at a high speed by the reduced rotational drive power. An airflow directed downward of the aircraft is generated by the rotation of the propeller 23, and thrust applied in the direction perpendicular to the aircraft is generated.

The load control ECU 5 is an electronic control unit that is formed of a CPU (Central Processing Unit), ROM (Read Only Memory), RAM (Random Access Memory), etc., and that executes a drive control over the loading apparatuses 7. The load control ECU 5 receives detection signals from the various sensors (not shown) that detect the state quantities required for the control. For example, when the load control ECU 5 is applied to the vertical takeoff and landing aircraft, the load control ECU 5 receives a detection signal (throttle signal) from a sensor that detects the thrust required by a pilot of the vertical takeoff and landing aircraft, and a detection signal (gyro signal) from a sensor that detects the attitude of the aircraft. The load control ECU 5 sets the target thrusts which should be produced by the respective loading apparatuses 7 based on the detection signals, and sets the target opening amounts by which the respective flow-rate control valves 6 should be opened to produce the target thrusts (i.e., sets the target air flow-rates). In addition, the load control ECU 5 prepares load flow-rate control signals according to which the flow-rate control valves 6 are opened by the target opening amounts, and transmits the load flow-rate control signals to the corresponding flow-rate control valves 6. The load control ECU 5 sets the required output based on the target thrusts, and transmits a required output signal indicating the required output to the engine control ECU 2. The ROM of the load control ECU 5 stores various maps or functions according to which the target thrusts, etc. are set.

The engine control ECU 2 is an electronic control unit that is formed of a CPU, ROM, RAM, etc., and that controls combustion and the extracted air flow-rate in the gas-turbine engine 3. The engine control ECU 2 receives the detection signals from the various sensors. The engine control ECU 2 sets the flow-rate of the fuel that will be supplied to the combustion chamber 11, based on a required output signal from the load control unit ECU 5 and various detection signals. In addition, the engine control ECU 2 prepares a fuel control signal according to which the fuel flow-rate is achieved, and transmits the fuel control signal to the fuel injection device 16. The engine control ECU 2 sets the target opening amount for the blowoff control valve 4 based on the various detection signals. Further, the engine control ECU 2 prepares an extracted air flow-rate control signal according to which the blowoff control valve 4 is opened by the target opening amount, and transmits the extracted air flow-rate control signal to the blowoff control valve 4. The ROM of the engine control ECU 2 stores various maps and functions according to which the fuel flow-rate, etc. are set.

Especially, in the gas-turbine engine system 1, the supercharged air from the gas-turbine engine 3 is used as the high-temperature and high-pressure compressed air which is used as source of energy for the loading apparatuses 7. Therefore, the gas-turbine engine 3 needs to stably supply the air of which the flow-rate is required by the loading apparatuses 7. In order to stably supply the compressed air to the loading apparatuses 7, the engine control ECU 2 needs to control the gas-turbine engine 3 in the optimum manner. Therefore, the engine control ECU 2 executes the routine for detecting the flow-rate of the air flowing into the combustion chamber (hereinafter, referred to as the “combustion chamber inflow air flow-rate detection routine”), the routine for detecting the temperature of the gas present at the inlet of the turbine (hereinafter, referred to as the “turbine inlet gas temperature detection routine”), the routine for detecting the flow-rate of the extracted air (hereinafter, referred to as the “extracted air flow-rate detection routine”), the routine for controlling the maximum fuel flow-rate at the engine speed-up time (hereinafter, referred to as the “speed-up time maximum fuel flow-rate control routine”), and the routine for controlling the blowoff control valve (hereinafter, referred to as the “blowoff control valve control routine”). As the speed-up time maximum fuel flow-rate control routine, the first speed-up time maximum fuel flow-rate control routine or the second speed-up time maximum fuel flow-rate control routine is executed.

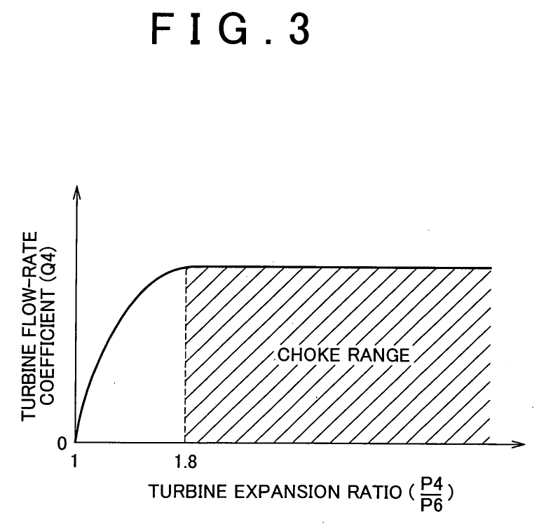

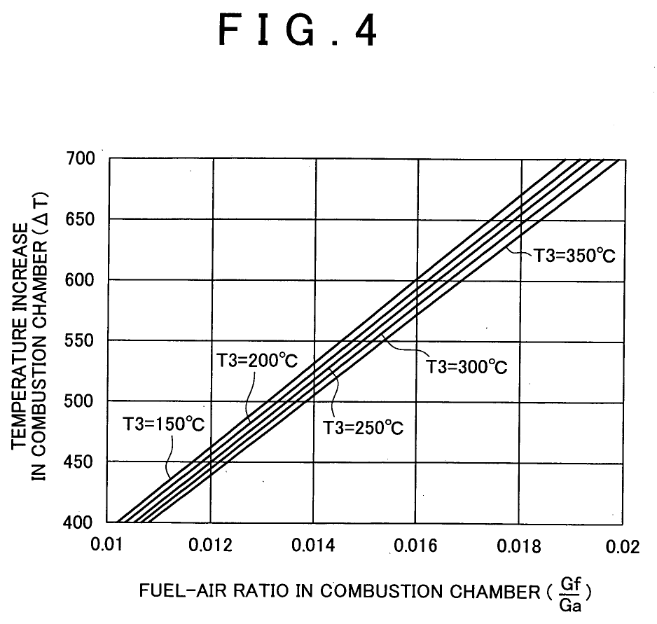

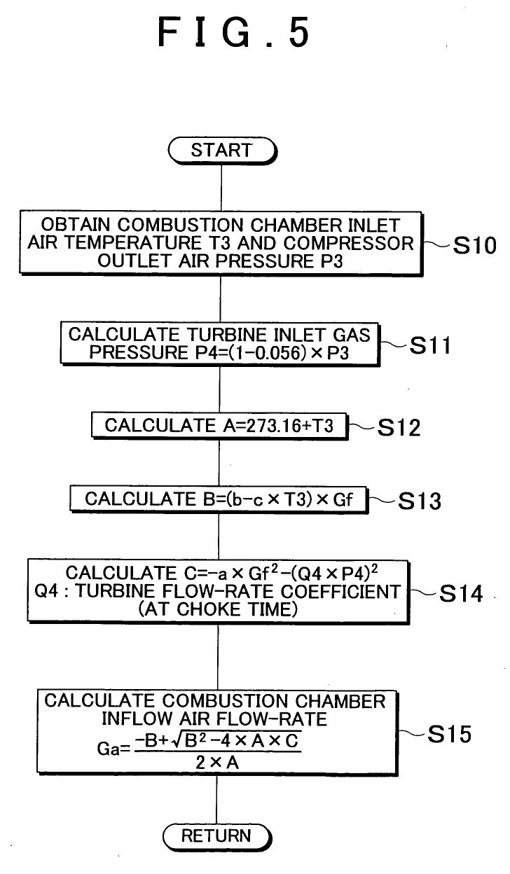

With reference to FIGS. 3 to 5, the combustion chamber inflow air flow-rate detection routine will be described. FIG. 3 is a graph showing the flow characteristic of the turbine of the gas-turbine engine. In FIG. 3, the turbine flow characteristic is the relationship between the turbine expansion ratio and the turbine flow-rate coefficient. FIG. 4 is a graph showing the temperature characteristic exhibited in the combustion chamber of the gas-turbine engine. In FIG. 4, the temperature characteristic is the relationship between the fuel-air ratio in the combustion chamber and an increase in the temperature in the combustion chamber, when the temperature of the air at the inlet of the combustion chamber is used as a parameter. FIG. 5 is a flowchart showing the combustion chamber inflow air flow-rate detection routine, which is executed by the engine control ECU 2 in FIG. 1.

Because the engine control ECU 2 sets the flow-rate Gf of the fuel that will be supplied to the combustion chamber 11, based on the flow-rate of the compressed air flowing from the compressor 10 into the combustion chamber 1 (hereinafter, referred to as the “in-flow air flow-rate Ga”), the in-flow air flow-rate Ga needs to be accurately determined. However, with the gas-turbine engine system 1, the compressed air from the compressor 10 is taken to the outside of the engine to be used as the source of energy for the loading apparatuses 7. Therefore, the extracted air flow-rate Ga_e changes. The in-flow air flow-rate Ga changes in accordance with a change in the extracted air flow-rate Ga_e. Therefore, the combustion chamber inflow air flow-rate detection routine is executed. In this way, the in-flow air flow-rate Ga is accurately determined without using a sensor, independently of a change in the extracted air flow-rate Ga_e.

The gas-turbine engine usually has the turbine flow characteristic shown in FIG. 3. In FIG. 3, the abscissa axis represents the turbine expansion ratio (i.e., the pressure P4 of gas at the inlet of the turbine/the pressure P6 of gas at the outlet of the turbine), and the ordinate axis represents the turbine flow-rate coefficient Q4. When the turbine is formed of a nozzle, the flow of the combustion gas chokes when the turbine expansion ratio exceeds a threshold value (i.e., the speed, at which the combustion gas flows, is maintained substantially constant when the turbine expansion ratio exceeds the lower limit of the choke range). The lower limit of the choke range is 1.8 when the turbine is a single-step simple nozzle, and 2 to 2.5 when the turbine is a double-step nozzle.

The flow-rate coefficient Q4 based on the above-described turbine characteristic is defined by Equation (1), and is substantially constant in the choke range. When the type of the gas-turbine engine is determined, the flow-rate coefficient Q4 becomes a specific value corresponding to the type of the engine in the choke range. In the combustion chamber inflow air flow-rate detection routine, the in-flow air flow-rate Ga is calculated using the characteristic based on which the turbine speed chokes (i.e., the turbine speed is maintained substantially constant) in the actual use range of the gas-turbine engine. In Equation (1), G4 is the flow-rate of the gas flowing into the turbine, T4 is the temperature of the gas at the inlet of the turbine, and P4 is the pressure of the gas at the inlet of the turbine.

$$Q 4 ≡ \frac{G 4 \times \sqrt{T 4}}{P 4} = const \qquad ( 1 )$$

It is considered that the turbine inlet gas temperature T4 is the sum of the combustion chamber inlet air temperature T3 and the temperature increase ΔT due to combustion that takes place in the combustion chamber. Therefore, the turbine inlet gas temperature T4 is calculated according to Equation (2). In this case, the combustion chamber inlet air temperature T3 is easily detected by a sensor. Therefore, if the temperature increase ΔT in the combustion chamber is accurately determined, the turbine inlet gas temperature T4 is determined.

T4=273.16+T3+ΔT (2)

FIG. 4 shows a thermodynamically-based temperature increase characteristic exhibited in the combustion chamber. In FIG. 4, the abscissa axis represents the combustion chamber fuel-air ratio (=fuel flow-rate Gf/in-low air flow-rate Ga), the ordinate axis represents the temperature increase ΔT in the combustion chamber, and the combustion chamber inlet air temperature T3 is used as a parameter. As shown in FIG. 4, the temperature increase ΔT in the combustion chamber is indicated by a function of the combustion chamber inlet air temperature T3 and the fuel-air ratio. According to the embodiment of the invention, Equation (3) is formulated in order to determine the temperature increase ΔT in the combustion chamber. In Equation (3), a, b, and c are constants that are set in advance.

$$Δ T = - a \times {( \frac{Gf}{Ga} )}^{2} + ( b - c \times T 3 ) \times ( \frac{Gf}{Ga} ) \qquad ( 3 )$$

Equation (1) can be converted into Equation (4). Incorporating Equation (2) and Equation (3) into Equation (4) formulates Equation (5).

$$\begin{matrix}G 4 \times \sqrt{T 4} = Q 4 \times P 4 & ( 4 ) \\ G 4 \times \sqrt{( 273.16 + T 3 ) + ( - a \times {( \frac{Gf}{Ga} )}^{2} + ( b - c \times T 3 ) \times ( \frac{Gf}{Ga} ) )} = Q 4 \times P 4 & ( 5 )\end{matrix}$$

It is basically considered that the turbine in-flow gas flow-rate G4 is the sum of the combustion chamber in-flow air flow-rate Ga and the flow-rate Gf of the fuel supplied into the combustion chamber. Therefore, it is considered that the turbine in-flow gas flow-rate G4 is higher than the in-flow air flow-rate Ga by the fuel flow-rate Gf. However, in the actual gas-turbine engine, leakage of the air, etc. occur in the passage in the engine. Therefore, it can be safely said that the turbine in-flow gas flow-rate G4 is substantially equal to the combustion chamber in-flow air flow-rate Ga. Accordingly, if the turbine in-flow gas flow-rate G4 is equal to the combustion chamber in-flow flow-rate Ga, Equation (5) is converted into Equation (6).

$$G a \times \sqrt{( 273.16 + T 3 ) + ( - a \times {( \frac{Gf}{Ga} )}^{2} + ( b - c \times T 3 ) \times ( \frac{Gf}{Ga} ) )} = Q 4 \times P 4 \qquad ( 6 )$$

Equation (6) is decomposed into Equation (7). When A represents Equation (8), B represents Equation (9), C represents Equation (10), and Equation (7) is converted into the equation according to which the combustion chamber in-flow air flow-rate Ga is derived, Equation (11) is formulated. Because it is known that the turbine inlet gas pressure P4 decreases from the compressor outlet air pressure P3 by an amount corresponding to the pressure loss that occurs while the gas flows to the inlet of the turbine. Therefore, in the embodiment of the invention, the turbine inlet gas pressure P4 is determined in a simple method based on the outlet air pressure P3, according to Equation (12). In the combustion chamber inflow air flow-rate detection routine, P4 is determined according to Equation (12), A, B, and C are determined according to Equation (8), Equation (9), and Equation (10), respectively, and the combustion chamber in-flow air flow-rate Ga is determined according to Equation (11).

$$\begin{matrix}( 273.16 + T 3 ) \times {Ga}^{2} + ( b - c \times T 3 ) \times Gf \times Ga - a \times {Gf}^{2} - {( Q 4 \times P 4 )}^{2} = 0 & ( 7 ) \\ A = ( 273.16 + T 3 ) & ( 8 ) \\ B = ( b - c \times T 3 ) \times Gf & ( 9 ) \\ C = - a \times {Gf}^{2} - {( Q 4 \times P 4 )}^{2} & ( 10 ) \\ Ga = \frac{- B + \sqrt{{B}^{2} - 4 \times A \times C}}{2 \times A} & ( 11 ) \\ P 4 = ( 1 - 0.056 ) \times P 3 & ( 12 )\end{matrix}$$

Hereafter, the combustion chamber inflow air flow-rate detection routine, which is executed by the engine control ECU 2, will be described with reference to the flowchart in FIG. 5. The engine control ECU 2 periodically executes the following routine at predetermined time intervals. The engine control ECU 2 receives detection signals from the various sensors to obtain the inlet air temperature T3 of the combustion chamber 11 and the outlet air pressure P3 of the compressor 10 (S10). Then, the engine control ECU 2 calculates the inlet gas pressure P4 of the turbine 12 based on the outlet air pressure P3 of the compressor 10, according to Equation (12) (S11). The engine control ECU 2 calculates A based on the inlet air temperature T3 of the combustion chamber 11, according to Equation (8) (S12). The engine control ECU 2 calculates B based on the inlet air temperature T3 of the combustion chamber 11 and the flow-rate Gf of the fuel supplied to the combustion chamber 11 in the immediately preceding routine, according to Equation (9) (S13). The engine control ECU 2 calculates C based on the flow-rate Gf of the fuel supplied to the combustion chamber 11 in the immediately preceding routine, the turbine flow-rate coefficient Q4 when the flow of the combustion gas chokes, and the inlet gas pressure P4 of the turbine 12, according to Equation (10) (S14). Finally, the engine control ECU 2 calculates the in-flow air flow-rate Ga of the combustion chamber 11 using A, B and C, according to Equation (11) (S15).

Usually, the engine-control ECU 2 sets the flow-rate Gf of the fuel that will be supplied to the combustion chamber 11 using, for example, a map, based on the calculated in-flow air flow-rate Ga. Then, the engine control ECU 2 transmits, to the fuel injection device 16, a fuel control signal according to which the fuel of which the flow-rate is Gf is supplied to the combustion chamber 11. The fuel injection device 16 injects fuel into the combustion chamber 11 based on the fuel control signal. In the combustion chamber 11, the injected fuel (having the fuel flow-rate Gf) and the compressed air (having the in-flow air flow-rate Ga) supplied from the compressor 10 are mixed together and burned, whereby high-temperature and high-pressure combustion gas is generated.

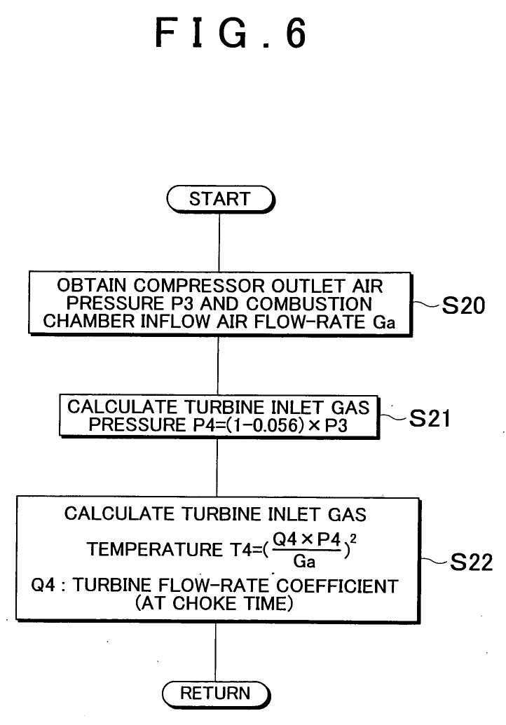

The turbine inlet gas temperature detection routine will be described with reference to FIG. 6. FIG. 6 is a flowchart showing the turbine inlet gas temperature detection routine, which is executed by the engine control ECU 2 in FIG. 1.

The turbine inlet gas temperature T4 is the highest temperature in the gas-turbine engine 3. Because the turbine inlet gas temperature T4 is considerably high, it is difficult to directly detect the turbine inlet gas temperature T4 using, for example, a temperature sensor. If the turbine inlet gas temperature T4 is excessively high, the possibility that a malfunction occurs in the turbine increases. Therefore, the permissible maximum temperature is set for the turbine inlet gas temperature T4. Therefore, it is necessary to execute the combustion control to operate the gas-turbine engine 3 in a manner such that the turbine inlet gas temperature T4 is equal to or lower than the permissible maximum temperature.

When Equation (1), according to which the flow-rate coefficient Q4 based on the turbine characteristic is derived, is converted into the equation according to which the turbine inlet gas temperature T4 is determined, Equation (13) is formulated. As described above, it can be safely said that the turbine in-flow gas flow-rate G4 is substantially equal to the combustion chamber in-flow air flow-rate Ga, the turbine in-flow gas flow-rate G4 can be replaced with the combustion chamber in-flow air flow-rate Ga in Equation (13). In the turbine inlet gas temperature detection routine, the turbine inlet gas temperature T4 is determined based on the combustion chamber in-low air flow-rate Ga that is determined in the combustion chamber inflow air flow-rate detection routine, according to Equation (13).

$$T 4 = {( \frac{Q 4 \times P 4}{G 4} )}^{2} ≅ {( \frac{Q 4 \times P 4}{G a} )}^{2} \qquad ( 13 )$$

Hereafter, the turbine inlet gas temperature detection routine, which is executed by the engine control ECU 2, will be described with reference to the flowchart in FIG. 6. The engine control ECU 2 periodically executes the following routine at predetermined time intervals. The engine control ECU 2 receives detection signals from the various sensors to obtain the outlet air pressure P3 of the compressor 10 (S20). The engine control ECU 2 obtains the in-flow air flow-rate Ga of the combustion chamber 11, which is determined in the combustion chamber inflow air flow-rate detection routine (S20). Then, the engine control ECU 2 calculates the inlet gas pressure P4 of the turbine 12 based on the outlet air pressure P3 of the compressor 10, according to Equation (12) (S21). In addition, the engine control ECU 2 calculates the inlet gas temperature T4 of the turbine 12 based on the turbine flow-rate coefficient Q4 when the flow of the combustion gas chokes, the inlet gas pressure P4 of the turbine 12, and the in-flow air flow-rate Ga of the combustion chamber 11, according to Equation (13) (S22).

Usually, the engine control ECU 2 sets the fuel flow-rate Gf in such a manner that the calculated inlet gas temperature T4 is equal to or lower than the turbine permissible maximum temperature, and executes the combustion control.

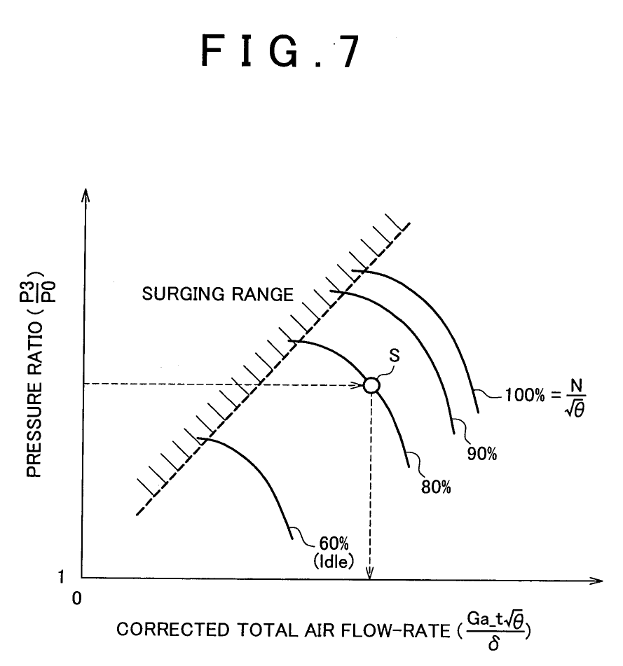

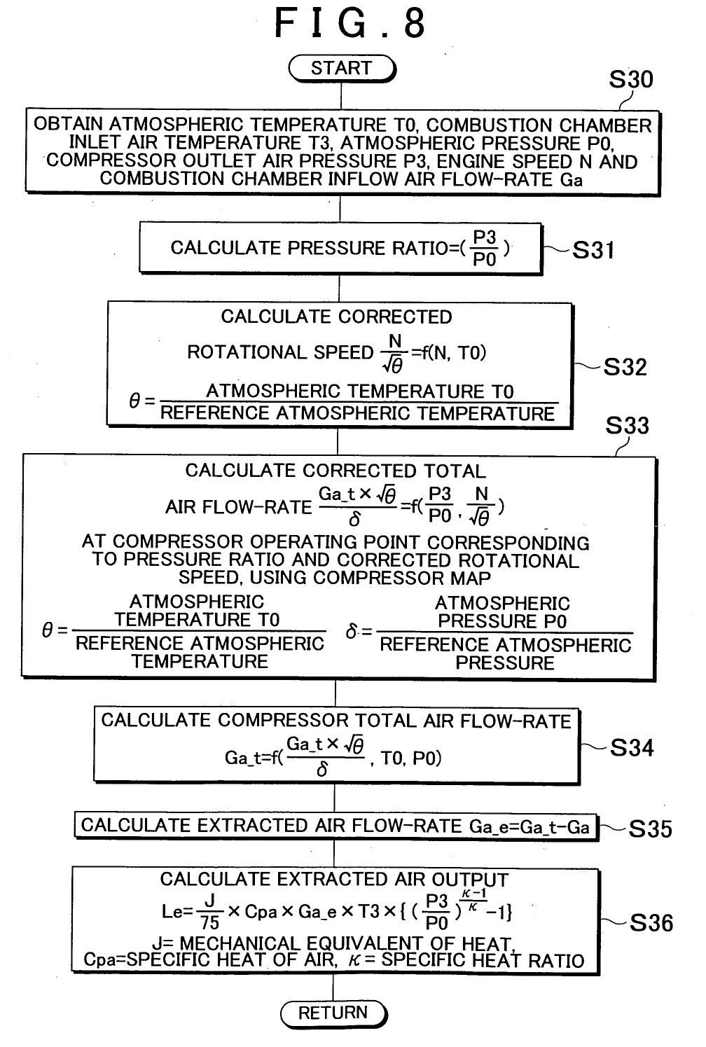

The extracted air flow-rate detection routine will be described with reference to FIGS. 7 and 8. FIG. 7 is a graph showing a compressor map (the map showing the relationship between the corrected total air flow-rate and the pressure ratio). FIG. 8 is a flowchart showing the extracted air flow-rate detection routine, which is executed by the engine control ECU 2 in FIG. 1.

In the extraction gas-turbine engine, the power is taken out from the engine in a form of the high-temperature and high-pressure compressed air. Accordingly, a large amount of air is extracted from the air which is supercharged by the compressor and which has the total air flow-rate Ga_t. The extracted air is used on the outside of the engine. Accordingly, in the actual gas-turbine engine, it is difficult to directly detect the extracted air flow-rate Ga_e using, for example, a sensor, because extracted air flow-rate Ga_e is considerably high. However, if the extracted air flow-rate Ga_e is not determined in the extraction engine, it is not possible to determine the actual load amount (output amount). Therefore, the combustion chamber in-flow air flow-rate Ga is accurately determined by executing the combustion chamber inflow air flow-rate detection routine. As a result, the extracted air flow-rate Ga_e is determined based on the combustion chamber in-flow air flow-rate Ga.

In the case of the extraction gas-turbine engine, the air having the flow-rate Ga flows into the combustion chamber. The air flow-rate Ga is obtained by subtracting the extracted air flow-rate Ga_e (the air flow-rate of the extracted air used on the outside of the engine) from the total air flow-rate Ga_t (the air flow-rate of the total amount of air supercharged by the compressor). Because the in-flow air flow-rate Ga is determined in the combustion chamber inflow air flow-rate detection routine, the extracted air flow-rate Ga_e is determined if the total air flow-rate Ga_t is determined. Therefore, the total air flow-rate Ga_t is determined using a compressor map shown in FIG. 7.

FIG. 7 shows a compressor map at each corrected rotational speed. In FIG. 7, the abscissa axis represents the corrected total air flow-rate, and the ordinate axis represents the pressure ratio (=compressor outlet air pressure P3/atmospheric pressure P0). In FIG. 7, θ is a value obtained by dividing the atmospheric temperature T0 by the reference atmospheric temperature (atmospheric temperature T0/reference atmospheric temperature), δ is a value obtained by dividing the atmospheric pressure P0 by the reference atmospheric pressure (atmospheric pressure P0/reference atmospheric pressure), and N is the engine speed. The corrected rotational speed is obtained by making the engine speed dimensionless using θ, the corrected total air flow-rate indicated by the abscissa axis is obtained by making the total air flow-rate Ga_t dimensionless using θ and δ, and the pressure ratio indicated by the ordinate axis is also dimensionless. These values are made dimensionless for the following reason. If the atmospheric temperature T0 or the atmospheric pressure P0 changes, the density of the air changes and the compressor characteristic changes. Accordingly, even when the atmospheric temperature T0 or the atmospheric pressure P0 changes, the compressor characteristic does not change if the above-described values are made dimensionless. In the range marked with diagonal lines in FIG. 7, power surges may occur in the compressor. It is necessary to operate the gas-turbine engine in such a manner that power surges in the compressor are avoided.

In FIG. 7, the solid curves show the characteristic exhibited by the compressor at each corrected rotational speed. The rated corrected rotational speed is 100%. The engine speed N (corrected rotational speed) of 100% is the permissible maximum speed in the gas-turbine engine, and the engine speed N of 60% is the idle speed. Therefore, if the corrected engine speed is determined based on the pressure ratio and the engine speed N (i.e., the rotational speed of the compressor) are determined, the corrected total air flow-rate at the operating point S of the compressor (consequently, the total air flow-rate Ga_t) is determined using the compressor map. In the extracted air flow-rate detection routine, the total air flow-rate Ga_t is determined based on the detection values from the various sensors, according to the compressor map, the extracted air flow-rate Ga_e is determined using the total air flow-rate Ga_t and the combustion chamber in-flow air flow-rate Ga determined in the combustion chamber inflow air flow-rate detection routine, and the extracted air output Le is determined.

The extracted air flow-rate detection routine, which is executed by the engine control ECU 2, will be described with reference to the flowchart in FIG. 8. The engine control ECU 2 periodically executes the following routine at predetermined time intervals. The engine control ECU 2 receives detection signals from the various sensors to obtain the atmospheric temperature T0, the inlet air temperature T3 of the combustion chamber 11, the atmospheric pressure P0, the outlet air pressure P3 of the compressor 10 and the engine speed N (S30). The engine control ECU 2 obtains the in-flow air flow-rate Ga of the combustion chamber 11, which is determined in the combustion chamber inflow air flow-rate detection routine (S30).

The engine control ECU 2 then calculates the pressure ratio by dividing the outlet air pressure P3 of the compressor 10 by the atmospheric pressure P0 (S31). The engine control ECU 2 calculates the corrected rotational speed based on the engine speed N and the atmospheric temperature T0, according to Equation (14) (S32). The engine control ECU 2 determines the corrected total air flow-rate at the operating point S of the compressor 10, which corresponds to the calculated pressure ratio and the corrected rotational speed, using the compressor map (Equation (15)) (S33). In addition, the engine control ECU 2 calculates the total air flow-rate Ga_t of the compressor 10 based on the atmospheric temperature T0, the atmospheric pressure P0, and the corrected total air flow-rate, according to Equation (16) (S34). Then, the engine control ECU 2 calculates the extracted air flow-rate Ga_e based on the total air flow-rate Ga_t and the in-flow air flow-rate Ga of the combustion chamber 11, according to Equation (17) (S35).

$$\begin{matrix}\frac{N}{\sqrt{θ}} = f ( N , T 0 ) & ( 14 ) \\ \frac{Ga\_t \times \sqrt{θ}}{δ} = f ( \frac{P 3}{P 0} , \frac{N}{\sqrt{θ}} ) & ( 15 ) \\ Ga\_t = f ( \frac{Ga\_t \times \sqrt{θ}}{δ} , T 0 , P 0 ) & ( 16 ) \\ Ga\_e = Ga\_t - Ga & ( 17 )\end{matrix}$$

The engine control ECU 2 calculates the extracted air output Le based on the inlet air temperature T3 of the combustion chamber 11, the calculated extracted air flow-rate Ga_e and the pressure ratio, according to Equation (18) (S36). In Equation (18), J indicates the mechanical equivalent of heat, Cpa indicates the specific heat of the air, and κ indicates the specific heat ratio. In this case, the extracted air output Le is determined based on the heat energy of the compressed air having the extracted air flow-rate Ga_e. The engine control ECU 2 sets the flow-rate Gf of the fuel which will be supplied to the combustion chamber 11 based on the actual extracted air output Le and the output required by the load control ECU 5, and executes the combustion control.

$$Le = \frac{J}{75} \times Cpa \times Ga\_e \times T 3 \times ( {( \frac{P 3}{P 0} )}^{\frac{κ - 1}{κ}} - 1 ) \qquad ( 18 )$$

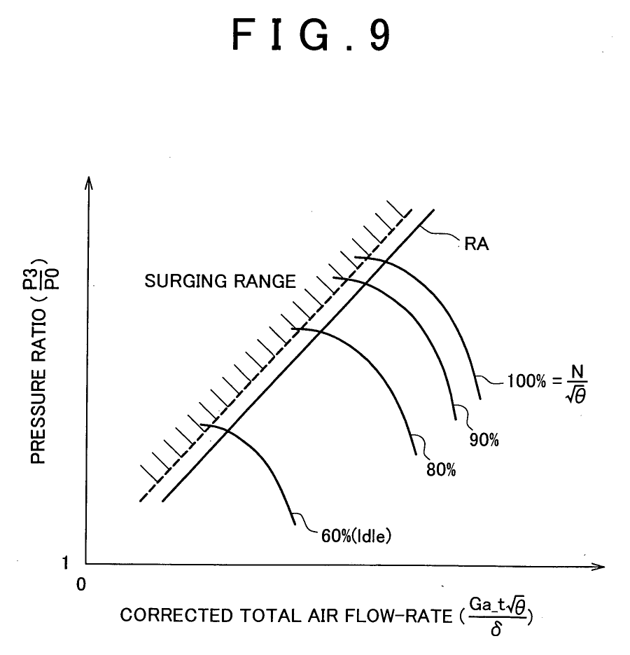

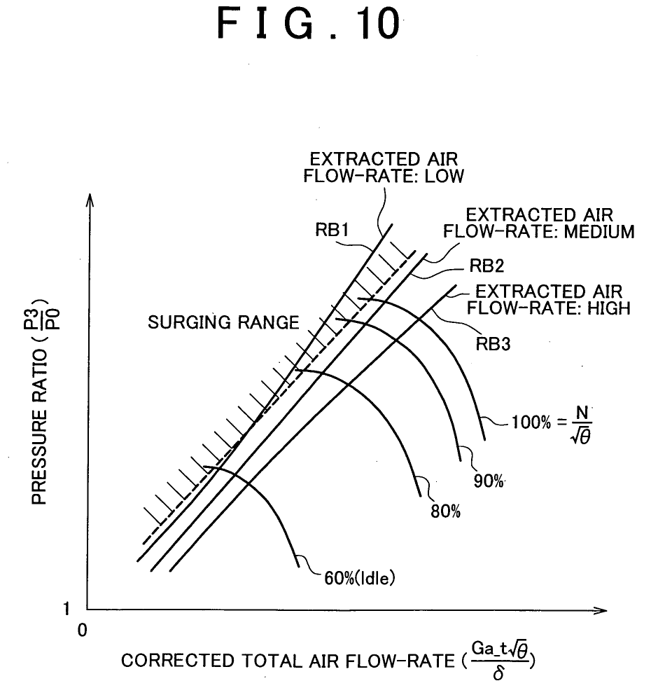

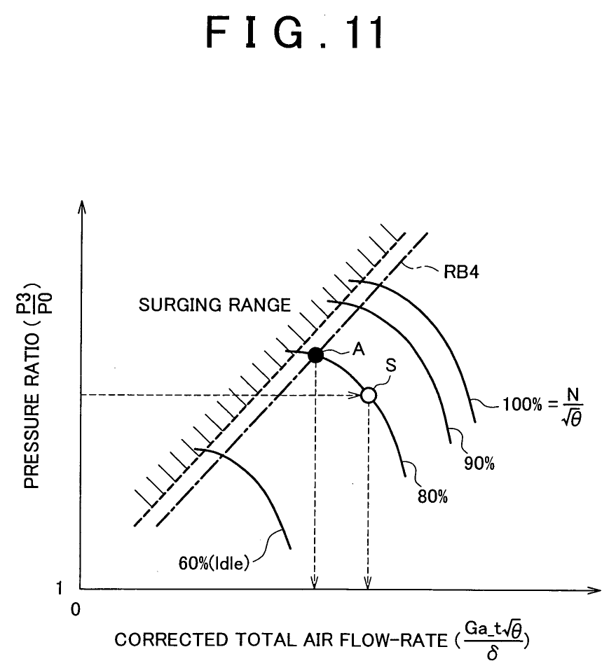

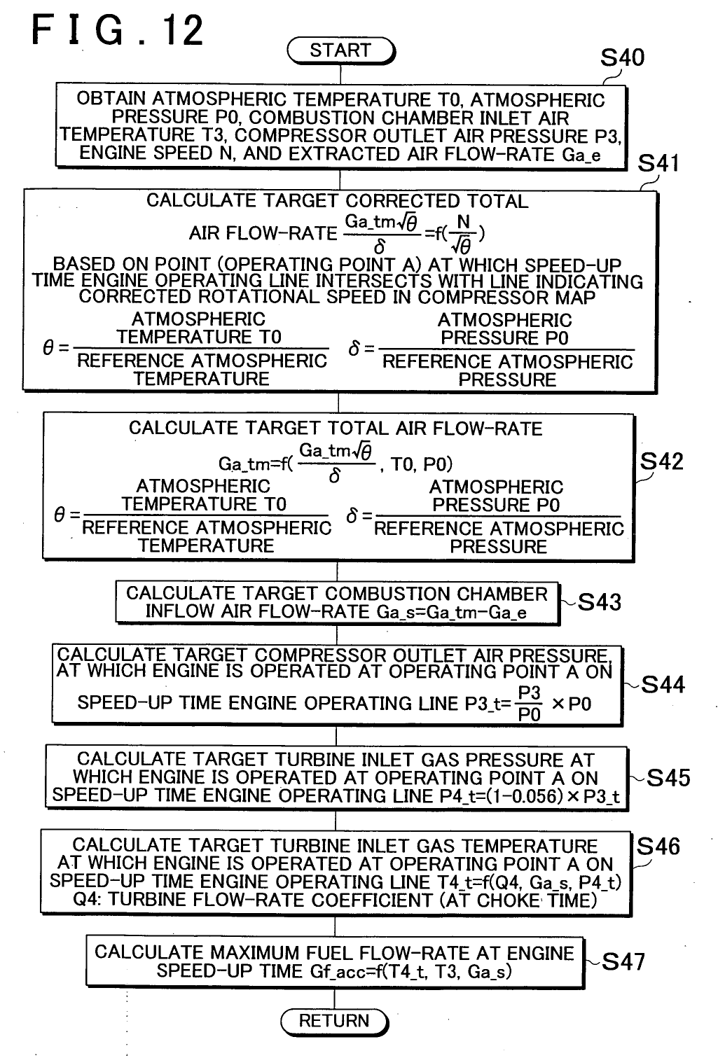

The first speed-up time maximum fuel flow-rate control routine will be described with reference to FIGS. 9 to 12. FIG. 9 is a graph showing a compressor map with the engine operating line in the case of the shaft-output gas-turbine engine. FIG. 10 is a graph showing a compressor map with the engine operating lines in the case of the extraction gas-turbine engine. FIG. 11 is a graph showing a compressor map with the speed-up time engine operating line. FIG. 12 is a flowchart showing the first speed-up time maximum fuel flow-rate control routine, which is executed by the engine control ECU 2 in FIG. 1.

In the shaft-output gas-turbine engine, the compressed air, which is supercharged by the compressor and which has the total air flow-rate, flows into the combustion chamber. Therefore, the engine operating line that is obtained when the turbine inlet gas temperature is constant can be indicated by one operating line in the compressor map. In FIG. 9, one operating line RA is indicated in the compressor map as the engine operating line that is obtained when the turbine inlet gas temperature in the shaft-output engine is constant. Therefore, in the case of the shaft-output engine, the maximum fuel flow-rate at each rotational speed when the engine speed is increasing is usually set in such a manner that the turbine inlet gas temperature T4 matches the permissible maximum temperature while the operating state of the compressor does not enter the surging range of the compressor (i.e., does not exceed the surging border).

In the extraction gas-turbine engine, the compressed air, which has the extracted air flow-rate Ga_e, within the compressed air, which is supercharged by the compressor and which has the total air flow-rate Ga_t, is used on the outside of the engine, and the remaining compressed air, which has the air flow-rate Ga, is supplied into the combustion chamber. Therefore, the air flow-rate Ga changes in accordance with the extracted air flow-rate Ga_e. In FIG. 10, the engine operating lines that are obtained when the turbine inlet gas temperature T4 in the extraction engine is constant are indicated by the three operating lines RB1, RB2, and RB3 depending on the extracted air flow-rate Ga_e in the compressor map. As shown in FIG. 10, when the turbine inlet gas temperature T4 is constant, as the extracted air flow-rate Ga_e decreases, the operating state of the compressor more easily enters the surging range. If the extracted air flow-rate Ga_e becomes considerably low, the operating state of the compressor enters the surging range. Accordingly, the turbine inlet gas temperature T4 needs to be changed in accordance with the extracted air flow-rate Ga_e in order to avoid power surges in the compressor.

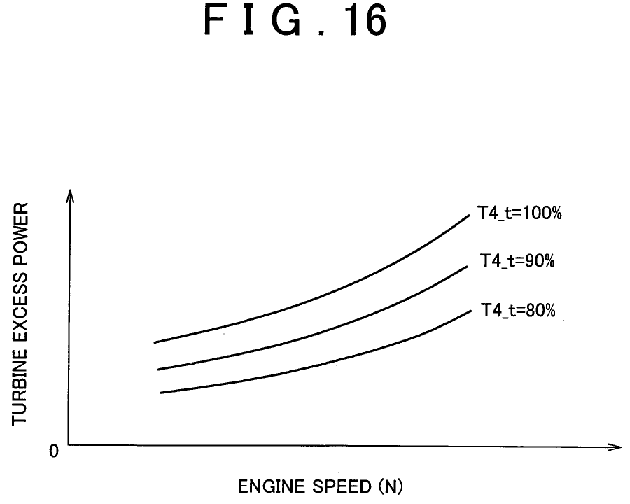

As the turbine inlet gas temperature T4 increases, the engine speed-up performance is enhanced because the excess power from the turbine increases (see FIG. 16). At this time, optimally, the turbine inlet gas temperature T4 is maintained at the permissible maximum temperature. Therefore, if the load control ECU 5 issues a request to increase the engine speed, the turbine inlet gas temperature T4 needs to be maintained high to the extent that power surges do not occur in the compressor. Therefore, in the speed-up time maximum fuel flow-rate control routine, when the engine speed is increased, the maximum fuel flow-rate Gf_acc, at which the optimum engine speed-up performance is exhibited, is set so as to maintain the turbine inlet gas temperature T4 as high as possible while avoiding power surges in the compressor. Therefore, in the first speed-up time maximum fuel flow-rate control routine, the target combustion chamber in-flow air flow-rate Ga_s and the turbine inlet gas temperature T4_t are estimated and the maximum fuel flow-rate Gf_acc is set in such a manner that the operating point A of the compressor is positioned on the speed-up time engine operating line RB4 that is set near the border of the surging range in the compressor map in FIG. 11. The speed-up time engine operating line RB4 should be as close as possible to the border of the surging range in order to increase the turbine inlet gas temperature T4 and enhance the engine speed-up performance. Usually, the speed-up time engine operating line RB4 is set at a position that is somewhat apart from the border of the surging range for safety. In this way, the operating state of the compressor does not enter the surging range.

Hereafter, the first speed-up time maximum fuel flow-rate control routine, which is executed by the engine control ECU 2, will be described with reference to the flowchart in FIG. 12. The engine control ECU 2 periodically executes the following routine at predetermined time intervals. The engine control ECU 2 receives detection signals from the various sensors to obtain the atmospheric temperature T0, the atmospheric pressure P0, the inlet air temperature T3 of the combustion chamber 11, the outlet air pressure P3 of the compressor 10 and the engine speed N (S40). The engine control ECU 2 obtains the extracted air flow-rate Ga_e that is determined in the extracted air flow-rate detection routine (S40).

The engine control ECU 2 calculates the corrected rotational speed based on the engine speed N and the atmospheric temperature T0, according to the similar calculation method employed in the extracted air flow-rate detection routine. Then, the engine control ECU 2 calculates the target corrected total air flow-rate based on the point (the operating point A) at which the speed-up time engine operating line RB4 intersects with the line indicating the corrected rotational speed in the compressor map (Equation (19)) (S41). In FIG. 11, the operating point A is the operating point of the compressor when the engine speed is increasing, and the operating point S is the operating point of the compressor in normal times. In addition, the engine control ECU 2 calculates the target total air flow-rate Ga_tm of the compressor 10 based on the atmospheric temperature T0, the atmospheric pressure P0, and the target corrected total air flow-rate, according to Equation (20) (S42). Then, the engine control ECU 2 calculates the target in-flow air flow-rate Ga_s of the combustion chamber 11 based on the calculated target total air flow-rate Ga_tm and the extracted air flow-rate Ga_e, according to Equation (21) (S43).

$$\begin{matrix}\frac{Ga\_tm \times \sqrt{θ}}{δ} = f ( \frac{N}{\sqrt{θ}} ) & ( 19 ) \\ Ga\_tm = f ( \frac{Ga\_tm \times \sqrt{θ}}{δ} , T 0 , P 0 ) & ( 20 ) \\ Ga\_s = Ga\_tm - Ga\_e & ( 21 )\end{matrix}$$

In the above-described steps, the target in-flow air flow-rate Ga_s of the combustion chamber 11 at the engine speed-up time is determined. However, it is necessary to determine the target inlet gas temperature T4_t of the turbine 12 at the engine speed-up time to determine the maximum fuel flow-rate Gf_acc at the engine speed-up time. Therefore, the target inlet gas temperature T4_t is determined using the characteristic according to which the flow-rate coefficient Q4 is maintained constant in the range in which the rotational speed of the turbine 12 chokes (actual use range of the engine).

First, the engine control ECU 2 determines the pressure ratio at the operating point A on the speed-up time engine operating line RB4 according to the compressor map. The engine control ECU 2 then calculates the target outlet air pressure P3_t of the compressor 10, at which the engine is operated at the operating point A on the speed-up time engine operating line RB4, based on the pressure ratio and the atmospheric pressure P0, according to Equation (22) (S44). In addition, the engine control ECU 2 calculates the target inlet gas pressure P4_t of the turbine 12, at which the engine is operated at the operating point A on the speed-up time engine operating line RB4, based on the calculated target outlet air pressure P3_t, according to Equation (23) (S45). Then, the engine control ECU 2 calculates the target inlet gas temperature of the turbine 12, at which the engine is operated at the operating point A on the speed-up time engine operating line RB4, based on the turbine flow-rate coefficient Q4 when the turbine speed chokes, the calculated target in-flow air flow-rate Ga_s and the target inlet gas pressure P4_t, according to Equation (24) (Equation (13)) (S46).

$$\begin{matrix}P 3 \_t = \frac{P 3}{P 0} \times P 0 & ( 22 ) \\ P 4 \_t = ( 1 - 0.056 ) \times P 3 \_t & ( 23 ) \\ P 4 \_t = f ( Q 4 , Ga\_s , P 4 \_t ) & ( 24 )\end{matrix}$$

Then, the engine control ECU 2 calculates the maximum flow-rate Gf_acc of the fuel that is supplied to the combustion chamber 11, at which the engine is operated at the operating point A on the speed-up time engine operating line RB4, based on the inlet air temperature T3 of the combustion chamber 11, the calculated target inlet gas temperature T4_t and the target in-flow air flow-rate Ga_s, according to Equation (25) (S47). In this case, because the inlet air temperature T3 and the target inlet gas temperature T4_t have already been determined, the temperature increase A in the combustion chamber 11 is determined according to Equation (2). If the temperature increase ΔT and the inlet air temperature T3 are used, the fuel-air ratio in the combustion chamber 11 is determined based on the temperature increase characteristic exhibited in the combustion chamber 11 in FIG. 4. Then, the maximum fuel flow-rate Gf_acc when the engine speed is increasing is determined based on the fuel-air ratio and the target in-flow air flow-rate Ga_s.

Gf_{—}acc=f(T4_{—}t,T3,Ga_{—}s) (25)

When the engine speed is increasing, the engine control ECU 2 transmits a fuel control signal, according to which the fuel having the calculated maximum fuel flow-rate Gf_acc is supplied to the combustion chamber 11, to the fuel injection device 16. The fuel injection device 16 injects the fuel into the combustion chamber 11 according to the fuel control signal. In the combustion chamber 11, the injected fuel (which has the maximum fuel flow-rate Gf_acc) and the compressed air supplied from the compressor 10 (which has the target in-flow air flow-rate Ga_s) are mixed together and burned, whereby high-temperature and high-pressure combustion gas is generated. At this time, the compressor 10 is operated at the operating point A on the speed-up time engine operating line RB4 (operated near the border of the surging range). Thus, the inlet gas temperature T4 of the turbine 12 is adjusted to the target inlet gas temperature T4_t.

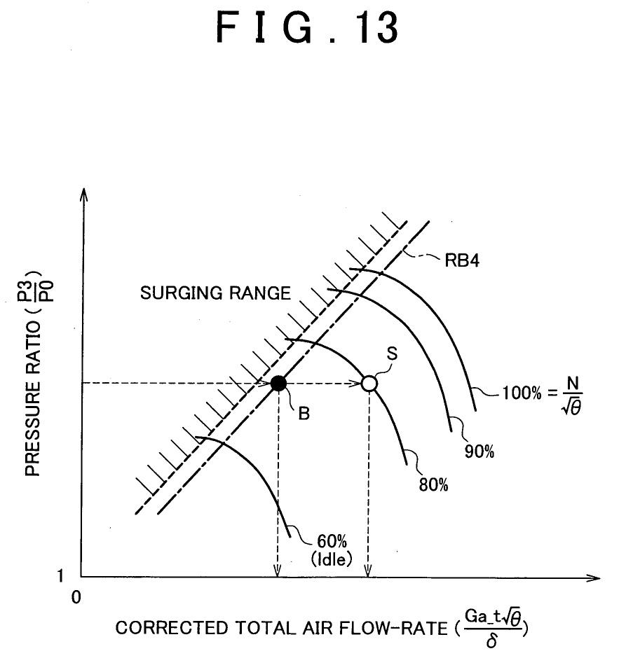

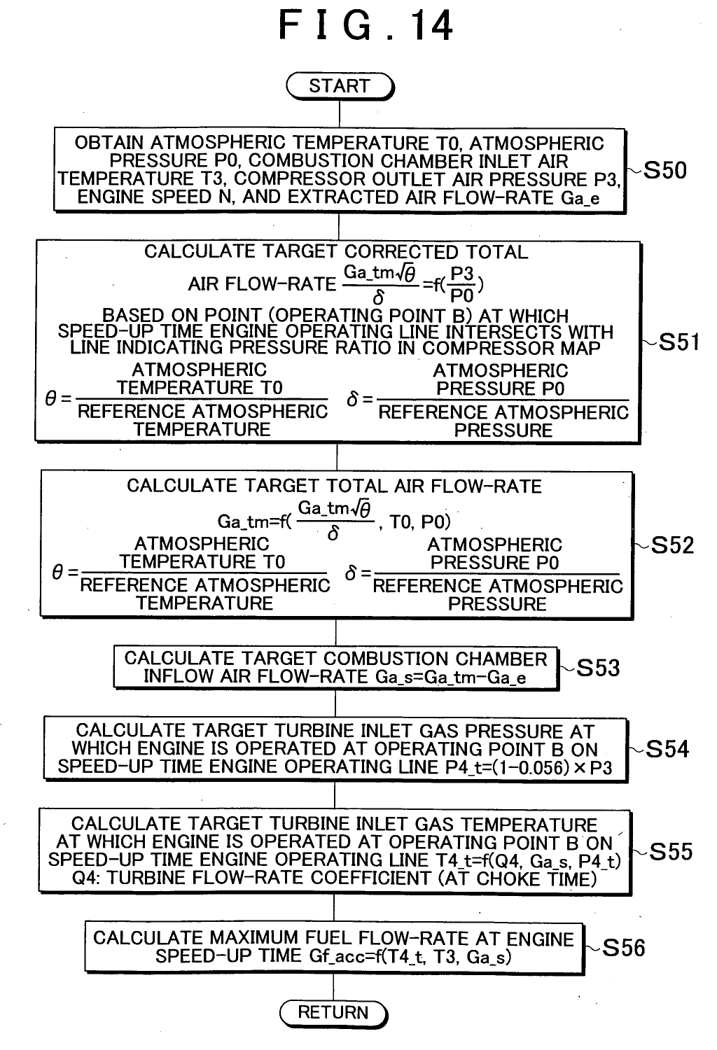

With reference to FIGS. 13 and 14, the second speed-up time maximum fuel flow-rate control routine will be described. FIG. 13 is a graph showing a compressor map with the speed-up time engine operating line. FIG. 14 is a flowchart showing the second speed-up time maximum fuel flow-rate control routine, which is executed by the engine control ECU 2 in FIG. 1.

The second speed-up time maximum fuel flow-rate control routine differs from the first speed-up time maximum fuel flow-rate control routine in that the operating point B on the speed-up time engine operating line RB4 is determined based on the actual pressure ratio using the actually detected outlet air pressure P3 of the compressor 10, and that the target inlet gas pressure P4_t of the turbine 12 is determined using the actual outlet air pressure P3. Because the actually measured value is used as the outlet air pressure P3 as described above, the control accuracy is enhanced. Even when the maximum fuel flow-rate Gf_acc is determined based on the operating point B, the actual engine speed N is not decreased because the fuel flow-rate is increasing. Therefore, the operating point is consequently shifted to the operating point A. However, the total air flow-rate at the operating point B is slightly lower than the total air flow-rate at the operating point A. Therefore, the maximum fuel flow-rate Gf_acc at the operating point B is lower than the maximum fuel flow-rate Gf_acc at the operating point A by the amount corresponding to the air flow-rate. Accordingly, it is possible to suppress an abrupt increase in the fuel flow-rate immediately after the engine operation state is shifted to the engine speed-up operation. As a result, combustion takes place more stably in the combustion chamber 11.

Then, the second speed-up time maximum fuel flow-rate control routine, which is executed by the engine control ECU 2, will be described with reference to the flowchart in FIG. 14. The engine control ECU 2 periodically executes the following routine at predetermined time intervals. The engine control ECU 2 obtains the atmospheric temperature T0, the atmospheric pressure P0, the inlet air temperature T3 of the combustion chamber 11, the outlet air pressure P3 of the compressor 10, the engine speed N, and the extracted air flow-rate Ga_e, by executing the process similar to that in step S40 in FIG. 12 (S50).

The engine control ECU 2 calculates the pressure ratio by dividing the outlet air pressure P3 of the compressor 10 by the atmospheric pressure P0. Then, the engine control ECU 2 determines the target corrected total air flow-rate based on the point (the operating point B) at which the speed-up time engine operating line RB4 intersects with the line indicating the pressure ratio in the compressor map (Equation (26)) (S51). In FIG. 13, the operating point B is the operating point of the compressor 10 when the engine speed is increasing, and the operating point S is the operating point of the compressor 10 in normal times. In addition, the engine ECU 2 calculates the target total air flow-rate Ga_tm of the compressor 10 by executing the process similar to that in step S42 in FIG. 12 (S52). The engine control ECU 2 calculates the target in-flow air flow-rate Ga_s of the combustion chamber 11 by executing the process similar to that in step S43 in FIG. 12 (S53).

$$\frac{Ga\_tm \times \sqrt{θ}}{δ} = f ( \frac{P 3}{P 0} ) \qquad ( 26 )$$

The engine control ECU 2 calculates the target inlet gas pressure P4_t of the turbine 12, at which the engine is operated at the operating point B on the speed-up time engine operating line RB4, based on the actual outlet air pressure P3 of the compressor 10, according to Equation (27) (S54). Then, the engine control ECU 2 calculates the target inlet gas temperature T4_t of the turbine 12, at which the engine is operated at the operating point B on the speed-up time engine operating line RB4, by executing the process similar to that in step S46 in FIG. 12 (S55). Further, the engine control ECU 2 calculates the maximum flow-rate Gf_acc of the fuel which will be supplied to the combustion chamber 11, at which the engine is operated at the operating point B on the speed-up time engine operating line RB4, by executing the process similar to that in step S47 in FIG. 12 (S56).

P4_{—}t=(1−0.056)×P3 (27)

When the engine speed is increasing, the fuel having the calculated maximum fuel flow-rate Gf_acc is burned in the combustion chamber 11 in the same manner as that in the first speed-up time maximum fuel flow-rate control routine. At this time, the compressor 10 is operated at the operating point B on the speed-up time engine operating line RB4 (i.e., is operated near the border of the surging range), and the inlet gas temperature T4 of the turbine 12 is adjusted to the target inlet gas temperature T4_t.

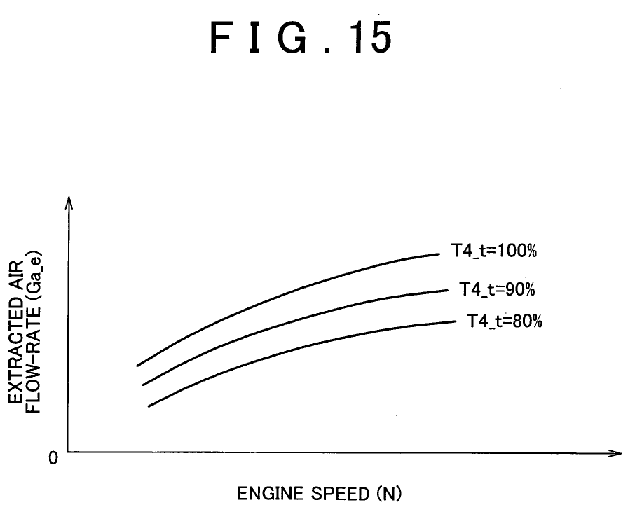

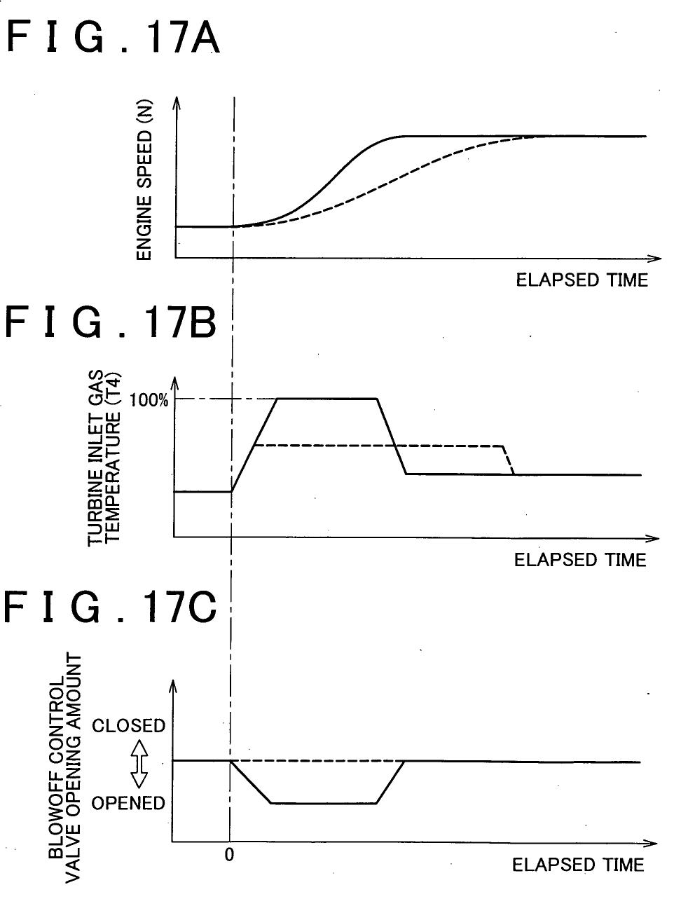

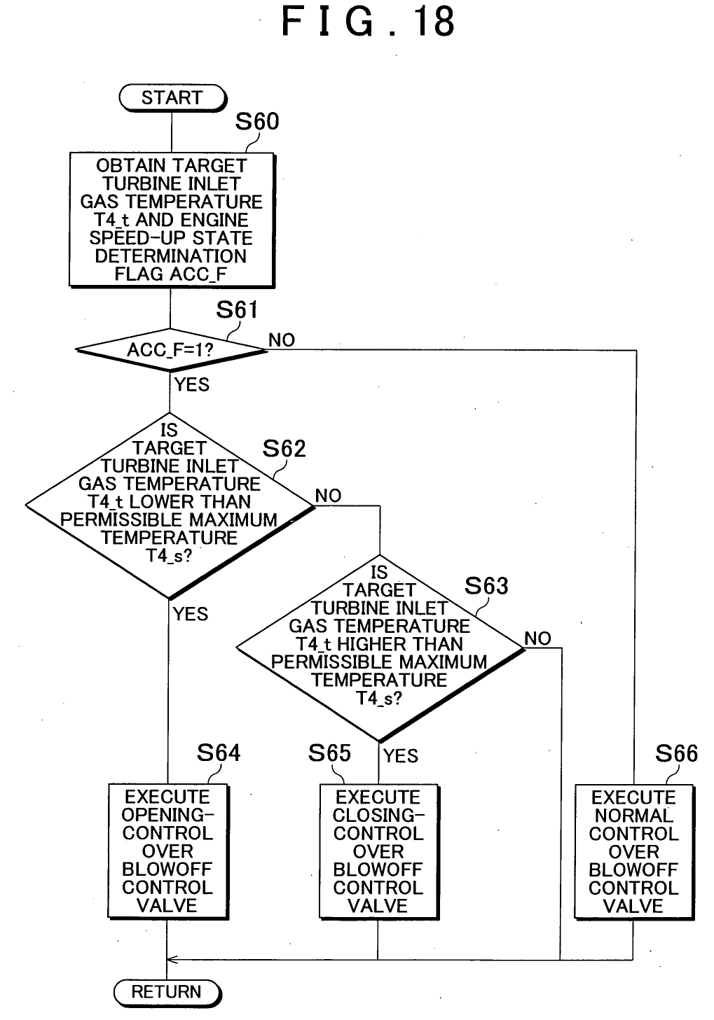

The blowoff control valve control routine will be described with reference to FIGS. 15 to 18. FIG. 15 shows the engine characteristics of the extraction gas-turbine engine, which are exhibited near the border of the surging range. FIG. 15 shows the relationship between the engine speed and the extracted air flow-rate, when the target turbine inlet gas temperature is used as a parameter. FIG. 16 shows the engine characteristics of the extraction gas-turbine engine, which are exhibited near the border of the surging range. FIG. 16 shows the relationship between the engine speed and the excess power from the turbine, when the target turbine inlet gas temperature is used as a parameter. FIGS. 17A to 17C are time charts showing the states when the engine speed is increasing. FIG. 17A is a time-change in the engine speed, FIG. 17B is a time-change in the turbine inlet gas temperature, and FIG. 17C is a time-change in the opening amount of the blowoff control valve. FIG. 18 is a flowchart showing the blowoff control valve control routine, which is executed by the engine control ECU 2 in FIG. 18.

As described above, in the extraction engine, it is necessary to maintain the turbine inlet gas temperature as high as possible while avoiding power surges in the compressor when the engine speed is increasing. However, if the flow-rate of the extracted air that is used on the outside of the engine is low, the operating state of the compressor is likely to enter the surging range. Accordingly, the turbine inlet gas temperature cannot be made high. Therefore, the turbine inlet gas temperature is maintained high (preferably, maintained at the permissible maximum temperature) by adjusting the extracted air flow-rate.

FIGS. 15 and 16 show the engine characteristics that are exhibited when the extracted air flow-rate is optimized near the border of the surging range for the extraction engine. FIG. 15 shows the relationship between the engine speed and the extracted air flow-rate when the target turbine inlet gas temperature is used as a parameter. FIG. 16 shows the relationship between the engine speed and the turbine excess power when the target turbine inlet gas temperature is used as a parameter. When the target turbine inlet gas temperature is 100%, the turbine inlet gas temperature matches the permissible maximum temperature. When the target turbine inlet gas temperature is 90%, the turbine inlet gas temperature is equal to a value obtained by multiplying the permissible maximum temperature by 0.9. The turbine excess power is the power obtained by subtracting the compressor-consumed horse power, the auxiliary driving horse power, the mechanical loss, etc., which are required to operate the engine, from the total power output from the turbine. The turbine excess power is used to increase the engine speed. Accordingly, the engine speed-up performance is more enhanced as the turbine excess power increases.

FIG. 15 shows the extracted air flow-rate that is required to bring the target turbine inlet gas temperature to a specified value (for example, 100%) near the border of the surging range. As shown in FIG. 15, the extracted air flow-rate needs to be increased in order to increase the target turbine inlet gas temperature in an area which is near the border of the surging range, and in which the operating state of the compressor does not enter the surging range. FIG. 16 shows the turbine excess power corresponding to the target turbine inlet gas temperature near the border of the surging range. As shown in FIG. 16, the turbine excess power is increased by increasing the target turbine inlet gas temperature. Therefore, in order to enhance the engine speed-up characteristic while avoiding power surges, it is necessary to optimize the extracted air flow-rate so as to maintain the target turbine inlet gas temperature as high as possible.

Therefore, the extracted air flow-rate on the gas-turbine engine 3 side is optimized using the blowoff control valve 4 in order to achieve the extracted air flow-rate required by the loading apparatuses 7 using the flow-rate control valves 6. The control over the blowoff control valve may be executed as follows. When the extracted air flow-rate required by the loading apparatuses 7 is low (when the operating point of the compressor easily enters the surging range), the opening amount of the blowoff control valve 4 is increased to increase the amount of air discharged into the atmosphere. As a result, a decrease in the extracted air flow-rate on the gas-turbine engine 3 side is prevented. On the other hand, when the extracted air flow-rate required by the loading apparatuses 7 is high (when the operating point of the compressor is apart from the surging range), the opening amount of the blowoff control valve 4 is decreased to decrease the amount of air discharged into the atmosphere. As a result, the extracted air flow-rate on the gas-turbine engine 3 side is not unnecessarily increased. Especially, in the blowoff control valve control routine, the extracted air flow-rate is optimized by adjusting the opening amount of the blowoff control valve 4 so that the target turbine inlet gas temperature matches the permissible maximum temperature (100%).

FIGS. 17A, 17B and 17C show examples of time-changes in the engine speed when the engine speed is increasing, the turbine inlet gas temperature, and the blowoff control valve opening amount. In each of FIGS. 17A, 17B and 17C, the solid line indicates the time-change achieved by the gas-turbine engine system 1, and the dashed line indicates the time-change achieved by the conventional system. With the gas-turbine engine system 1, when the engine speed is increased, the opening amount of the blowoff gas is increased to increase the extracted air flow-rate in such a manner that the operating point of the compressor does not enter the surging range, and the combustion control is executed to maintain the turbine inlet gas temperature at the permissible maximum temperature (100%). As a result, the turbine excess power increases, and the engine speed rapidly increases (the engine speed-up performance is enhanced). In contrast, with the conventional system, when the engine speed is increased, the extracted air flow-rate changes in accordance with a request from the loading apparatuses. Therefore, the combustion control is executed in accordance with a change in the extracted air flow-rate in such a manner that the operating point of the compressor does not enter the surging range. As a result, the turbine inlet gas temperature does not reach the permissible maximum temperature. Therefore, the turbine excess power is not increased, and the engine speed is not rapidly increased.

Next, the blowoff control valve control routine, which is executed by the engine control ECU 2, will be described with reference to the flowchart in FIG. 18. The engine control ECU 2 periodically executes the following routine at predetermined time intervals. The engine control ECU 2 obtains the target inlet gas temperature T4_t of the turbine 12, which is determined in the speed-up time maximum fuel flow-rate control routine, and the engine speed-up state determination flag ACC_F (S60). The engine speed-up state determination flag ACC_F is set to 1 when it is determined that the engine speed is increasing, and set to 0 in the states other than the engine speed-up state, for example, in the steady state.

The engine control ECU 2 determines whether the engine speed-up state determination flag ACC_F is set to 1 (S61). When it is determined in S61 that the engine speed-up state determination flag ACC_F is set to 0, the engine control ECU 2 executes the normal control over the blowoff control valve 4 (S66). In the normal control, the opening amount of the blowoff control valve 4 is controlled in accordance with the extracted air flow-rate required by the loading apparatuses 7 in such a manner that the operating point of the compressor 10 does not enter the surging range.

On the other hand, when it is determined in S61 that the engine speed-up state determination flag ACC_F is set to 1, the engine control ECU 2 determines whether the target inlet gas temperature T4_t of the turbine 12 is lower than the permissible maximum temperature T4_s (S62). When it is determined in S62 that the target inlet gas temperature T4_t is lower than the permissible maximum temperature T4_s, the extracted air flow-rate is excessively low. Therefore, in order to increase the extracted air flow-rate to increase the turbine inlet gas temperature, the engine control ECU 2 sets the target opening amount that is larger than that used in the immediately preceding routine, and transmits an extracted air flow-rate control signal indicating the target opening amount to the blowoff control valve 4 (S64). When the blowoff control valve 4 receives the extracted air flow-rate control signal, the actuator is driven to increase the opening amount of the blowoff control valve 4. As a result, the amount of compressed air discharged from the compressor 10 into the atmosphere increases, and the extracted air flow-rate Ga_e increases. Thus, the operating point of the compressor 10 is more unlikely to enter the surging range, and the target turbine inlet gas temperature is increased.

On the other hand, when it is determined in S62 that the target inlet gas temperature T4_t is equal to or higher than the permissible maximum temperature T4_s, the engine control ECU 2 determines whether the target inlet gas temperature T4_t of the turbine 12 is higher than the permissible maximum temperature T4_s (S63). When it is determined in S63 that the target inlet gas temperature T4_t is higher than the permissible maximum temperature T4_s, the extracted air flow-rate is excessively high. Therefore, in order to decrease the extracted air flow-rate to decrease the turbine inlet gas temperature, the engine control ECU 2 sets the target opening amount to a smaller value than that used in the immediately preceding routine, and transmits an extracted air flow-rate control signal indicating the target opening amount to the blowoff control valve 4 (S65). When the blowoff control valve 4 receives the extraction blow rate control signal, the actuator is driven to decrease the opening amount of the blowoff control valve 4. As a result, the amount of compressed air discharged from the compressor 10 into the atmosphere decreases, and the extracted air flow-rate Ga_e decreases. Thus, the operating point of the compressor 10 approaches the surging range, and the target turbine inlet gas temperature is decreased.

On the other hand, when it is determined in S63 that the target inlet gas temperature T4_t is equal to the permissible maximum temperature T4_s, the engine control ECU 2 does not perform the control over the blowoff control valve 4 in order to maintain the extracted air flow-rate to maintain the target turbine inlet gas temperature.

As described above, when the engine speed is increasing, the target inlet gas temperature T4_t is maintained at the permissible maximum temperature T4_s by adjusting the opening amount of the blowoff control valve 4, and the turbine excess power is increased. In addition, because the extracted air flow-rate Ga_e on the gas-turbine engine 3 side is adjusted, the control is executed in such a manner that the operating point of the compressor does not to enter the surging range.

The gas-turbine engine system 1 (especially, the engine control ECU 2) produces the following effects. First, executing the combustion chamber inflow air flow-rate detection routine makes it possible to accurately determine the in-flow air flow-rate Ga of the combustion chamber 11 without using special measurement means, independently of a change in the extracted air flow-rate Ga-e. Using the in/flow air flow-rate Ga makes it possible to execute accurate fuel flow-rate control and to operate the engine stably.

Also, executing the turbine inlet gas temperature detection routine makes it possible to accurately determine the inlet gas temperature T4 of the turbine 12, of which the temperature becomes considerably high, without using special measurement means. Using the inlet gas temperature T4 makes it possible to execute the combustion control in a manner such that the turbine inlet gas temperature T4 does not exceed the permissible maximum temperature.

Also, executing extracted air flow-rate detection routine makes it possible to accurately determine the extracted air flow-rate Ga_e without using special measurement means. Using the extracted air flow-rate Ga_e makes it possible to determine the load amount (output amount) as the extraction engine, and to execute accurate combustion control and load control.

Executing the speed-up time maximum fuel flow-rate control routine enables the operation on the speed-up time engine operating line even if the extracted air flow-rate Gf_acc changes, while avoiding occurrence of power surges in the compressor 10. Therefore, the maximum fuel flow-rate Gf_acc is optimized. Using the maximum fuel flow-rate Gf_acc makes it possible to execute accurate combustion control when the engine speed is increasing.

Also, executing the blowoff control valve control routine using the blowoff control valve 4 makes it possible to maintain the turbine inlet gas temperature at the permissible maximum temperature while avoiding occurrence of power surges in the compressor 10, when the engine speed is increasing. Thus, it is possible to increase the turbine excess power as much as possible, to enhance the engine speed-up performance, and execute the optimum combustion control when the engine speed is increasing.

While the invention has been described with reference to an example embodiment thereof, it is to be understood that the invention is not limited to the example embodiment. To the contrary, the invention is intended to cover various modifications and equivalent arrangements within the scope of the invention.

For example, in the embodiment described above, the invention is applied to the gas-turbine engine system that includes one uniaxial gas-turbine engine, and that is applied to the vertical takeoff and landing aircraft. However, the invention may be applied to a system that includes multiple gas-turbine engines, a multi-axial gas-turbine engine, or a system that includes only one loading apparatus. The invention may be applied to other various loading apparatuses that uses the extracted compressed air for energy.

In the embodiment of the invention described above, the blowoff control valve is provided, and the extracted air flow-rate can be adjusted. However, the structure that does not include the blowoff control valve may be employed.

In the embodiment of the invention described above, the engine control ECU executes the combustion chamber inflow air flow-rate detection routine, the turbine inlet gas temperature detection routine, the extracted air flow-rate detection routine, the speed-up time maximum fuel flow-rate control routine, and the blowoff control valve control routine are all executed. However, only one or some of these controls may be executed.

In the embodiment of the invention, the turbine inlet gas pressure P4 is determined based on the compressor outlet air pressure P3 in a simple method. Alternatively, the turbine inlet gas pressure P4 may be determined in another method, or measured by, for example, a sensor.

What is claimed is:

1. A control apparatus for a gas-turbine engine that is configured in such a manner that a portion of compressed air from a compressor is supplied to a combustion chamber and the other portion of the compressed air is sent to an outside of the engine to be used as source of energy, and a turbine is rotated by combustion gas produced in the combustion chamber, comprising:
a characteristic value detection unit that detects a characteristic value exhibited by the turbine; and
a physical quantity calculation unit that calculates a physical quantity related to air in the gas-turbine engine, using the characteristic value detected by the characteristic value detection unit.

2. The control apparatus according to claim 1, wherein the physical quantity related to the air in the gas-turbine engine is a flow-rate of the air supplied to the combustion chamber.

3. The control apparatus according to claim 2, wherein:
the characteristic value exhibited by the turbine is a flow-rate coefficient of the turbine; and
the control apparatus further comprises a first combustion chamber-supplied air flow-rate calculation unit that calculates the flow-rate of the air supplied to the combustion chamber using the flow-rate coefficient of the turbine, when an operating state of the turbine is in a range in which the turbine chokes.

4. The control apparatus according to claim 3, further comprising:
a turbine-supplied gas flow-rate detection unit that detects a flow-rate of the gas supplied to the turbine when the operating state of the turbine is in the range in which the turbine chokes;
a turbine-inlet gas pressure detection unit that detects a pressure of the gas at an inlet of the turbine;
a fuel-air ratio determination unit that determines a fuel-air ratio in the combustion chamber; and
a second combustion chamber-supplied air flow-rate calculation unit that calculates the flow-rate of the air supplied to the combustion chamber using the flow-rate of the gas supplied to the turbine, the pressure of the gas at the inlet of the turbine, and the fuel-air ratio in the combustion chamber, according to a turbine flow-rate coefficient equation.

5. The control apparatus according to claim 1, wherein the physical quantity related to the air in the gas-turbine engine is a temperature of the gas at an inlet of the turbine.

6. The control apparatus according to claim 5, wherein:
the characteristic value exhibited by the turbine is a flow-rate coefficient of the turbine; and
the control apparatus further comprises a first turbine-inlet gas temperature calculation unit that calculates the temperature of the gas at the inlet of the turbine using the flow-rate coefficient of the turbine, when an operating state of the turbine is in a range in which the turbine chokes.

7. The control apparatus according to claim 6, further comprising:
a combustion chamber-supplied air flow-rate detection unit that detects a flow-rate of the air supplied to the combustion chamber, when the operating state of the turbine is in the range in which the turbine chokes;
a turbine-inlet gas pressure detection unit that detects a pressure of the gas at the inlet of the turbine; and
a second turbine-inlet gas temperature calculation unit that calculates the temperature of the gas at the inlet of the turbine using the flow-rate of the air supplied to the combustion chamber and the pressure of the gas at the inlet of the turbine, according to a turbine flow-rate coefficient equation.

8. The control apparatus according to claim 1, wherein
the physical quantity related to the air in the gas-turbine engine is an extracted air flow-rate of the air taken out from the compressor as the source of energy,
the characteristic value exhibited by the turbine is a flow-rate coefficient of the turbine, and
the control apparatus further comprises:
a supercharged air flow-rate detection unit that detects a flow-rate of air supercharged by the compressor; and
an extracted air flow-rate calculation unit that calculates the extracted air flow-rate based on a difference between the flow-rate of the supercharged air and a flow-rate of the air supplied to the combustion chamber, which is determined based on the flow-rate coefficient of the turbine.

9. A control apparatus for a gas-turbine engine that is configured in such a manner that a portion of compressed air from a compressor is supplied to a combustion chamber and the other portion of the compressed air is sent to an outside of the engine to be used as source of energy, and a turbine is rotated by combustion gas produced in the combustion chamber, comprising:
a target combustion chamber-supplied air flow-rate detection unit that detects a target flow-rate of the air supplied to the combustion chamber when an operating state of the compressor is near a border of a surging range of the compressor;
a target temperature determination unit that determines a target temperature of gas at an inlet of the turbine; and
a combustion chamber-supplied fuel flow-rate calculation unit that calculates a flow-rate of fuel supplied to the combustion chamber when an engine speed is increasing, using the target flow-rate of the air supplied to the combustion chamber and the target temperature of the gas at the inlet of the turbine.

10. The control apparatus according to claim 9, further comprising:
an extracted air flow-rate adjustment unit that releases air from the compressor; and
a released air flow-rate adjustment unit that adjusts a flow-rate of the air released from the compressor by the extracted air flow-rate adjustment unit so that the target temperature of the gas at the inlet of the turbine matches a permissible maximum temperature, when the engine speed is increasing.

11. A control apparatus for a gas-turbine engine that is configured in such a manner that a portion of compressed air from a compressor is supplied to a combustion chamber and the other portion of the compressed air is sent to an outside of the engine to be used as source of energy, and a turbine is rotated by combustion gas produced in the combustion chamber, comprising:
characteristic value detection means for detecting a characteristic value exhibited by the turbine; and
physical quantity calculation means for calculating a physical quantity related to air in the gas-turbine engine, using the characteristic value detected by the characteristic value detection means.

12. A control apparatus for a gas-turbine engine that is configured in such a manner that a portion of compressed air from a compressor is supplied to a combustion chamber and the other portion of the compressed air is sent to an outside of the engine to be used as source of energy, and a turbine is rotated by combustion gas produced in the combustion chamber, comprising:
target combustion chamber-supplied air flow-rate detection means for detecting a target flow-rate of the air supplied to the combustion chamber when an operating state of the compressor is near a border of a surging range of the compressor;
target temperature determination means for determining a target temperature of gas at an inlet of the turbine; and
combustion chamber-supplied fuel flow-rate calculation means for calculating a flow-rate of fuel supplied to the combustion chamber when an engine speed is increasing, using the target flow-rate of the air supplied to the combustion chamber and the target temperature of the gas at the inlet of the turbine.

13. A control method for a gas-turbine engine that is configured in such a manner that a portion of compressed air from a compressor is supplied to a combustion chamber and the other portion of the compressed air is sent to an outside of the engine to be used as source of energy, and a turbine is rotated by combustion gas produced in the combustion chamber, comprising:
detecting a characteristic value exhibited by the turbine; and
calculating a physical quantity related to air in the gas-turbine engine, using the characteristic value exhibited by the turbine.

14. A control method for a gas-turbine engine that is configured in such a manner that a portion of compressed air from a compressor is supplied to a combustion chamber and the other portion of the compressed air is sent to an outside of the engine to be used as source of energy, and a turbine is rotated by combustion gas produced in the combustion chamber, comprising:
detecting a target flow-rate of the air supplied to the combustion chamber when an operating state of the compressor is near a border of a surging range of the compressor;
determining a target temperature of gas at an inlet of the turbine; and
calculating a flow-rate of fuel supplied to the combustion chamber when an engine speed is increasing, using the target flow-rate of the air supplied to the combustion chamber and the target temperature of the gas at the inlet of the turbine.
